(19) United States
(12) Patent Application Publication
(10) Pub. No.: US 2025/0193644 A1
(43) Pub. Date: Jun. 12, 2025

(54) METHODS, SYSTEM, AND APPARATUS FOR COLLABORATIVE SENSING

(71) Applicant: Huawei Technologies Co., Ltd., Shenzhen (CN)

(72) Inventors: Ahmed Wagdy Abdelwahab Shaban, Kanata (CA); Alireza Bayesteh, Brossard (CA); Jianglei Ma, Ottawa (CA)

(21) Appl. No.: 19/058,893

(22) Filed: Feb. 20, 2025

Related U.S. Application Data
(63) Continuation of application No. PCT/CN2022/114512, filed on Aug. 24, 2022.

(51) Int. Cl. H04W 4/38; H04L 5/00; H04W 8/22

(52) U.S. Cl. CPC H04W 4/38; H04L 5/0051; H04W 8/22

(57) ABSTRACT

According to aspects of the present disclosure, a value of a parameter for a first apparatus may be used for a second apparatus responsive to determining that sensing information associated with both the first and second apparatus satisfies a threshold value.

### CROSS-REFERENCE TO RELATED APPLICATION

This application is a continuation of International Application No. PCT/CN2022/114512, filed on Aug. 24, 2022, the disclosure of which is hereby incorporated by reference in its entirety.

### TECHNICAL FIELD

The present disclosure relates to communication networks and, in particular, to sensing in communication networks.

### BACKGROUND

Providing network-wide sensing services and related emerging applications whilst accommodating both communication and sensing functionalities risks imposing huge bandwidth and power supply requirements on many nodes in the network, such as network devices and electronic devices. The heterogeneity of electronic devices' capabilities, use-cases, and applications results in only a portion of electronic devices in a network being capable of transmitting and/or processing ultra-wide bandwidth signals and having large power supplies (e.g., large power banks and batteries). This risks limiting the ability of the network to enable high-quality network-wide sensing services, which may hinder the adoption of emerging applications that utilize sensing.

Even if all electronic devices in a network could be equipped with all the sensing capabilities (such as large battery banks, high-power and large dynamic range hardware, and large bandwidth), existing sensing systems may require each electronic device to send its sensing measurements to the network through dynamic signaling. Alternatively, each electronic device may be required to send uplink reference signals to the network to enable sensing parameters to be estimated at the network side. This incurs a large signaling and time/frequency resource overhead, causing significant power consumption. These demands on signaling overhead and power consumption are expected to scale linearly with the number of electronic devices and applications using sensing services.

Methods for providing reliable high-resolution sensing information (e.g., network-wide sensing information) and services for electronic devices with limited energy and low bandwidth are thus desired.

### SUMMARY

Aspects of the present disclosure may reduce the energy and signaling overhead involved in network-wide sensing. Existing approaches for network-wide sensing may require large battery banks, high-power and large dynamic range hardware, and large bandwidth at all sensing nodes in order to provide network-wide sensing services and accommodate the emerging applications and use cases. In addition, existing approaches may incur a large signaling overhead required for collecting or providing such sensing services at all sensing nodes.

Communication networks are becoming increasingly dense, with increases in the number of base stations, as well as the number of antennas per node. As communication networks become increasingly dense, the serving areas of base stations are expected to decrease in size and the number of electronic devices, their utilities, and applications increase. As a result, electronic devices are expected to be more temporally and spatially correlated. These spatial and temporal correlations may be inherited by parameters associated with these electronic devices, such as sensing parameters. As a result, parameters for electronic devices which are spatially and/or temporally correlated may be related to one another by closed-formula mathematical relationships. The values of these parameters may vary only slightly from one electronic device to another, such that the parameter values for different electronic devices may be within certain measurable accuracy levels of one another.

These correlations may be exploited to reduce the resources involve in sensing parameters for multiple electronic devices. In particular, the heterogeneity of the capabilities of different electronic devices can be exploited by allowing cooperation among electronic devices in order to use the available resources at some electronic devices to aid sensing for other electronic devices. For example, available resources (e.g., available power) at more capable electronic devices may be used to aid sensing for other, less capable electronic devices. In particular, spatial and/or temporal correlations between cooperative electronic devices may be exploited to capture correlations among their sensing parameters to decrease the signaling overhead, processing capabilities, and power required for sensing estimation.

This can enable high-resolution sensing for electronic devices with limited capabilities (such as low power and/or limited energy). This is particular advantageous for next and future generation networks, in which sensing is expected to be a core service. In these next and future generation networks, an increasing number of electronic devices (e.g., the majority of electronic devices) are expected to have limited capabilities. This may include, for example, drones and Internet of Things (IoT) devices (e.g., low-end IoT devices). As such, aspects of the present disclosure relate to cooperative to enable high-resolution network-wide sensing, even for devices with limited capabilities.

According to aspects of the present disclosure, a value of a parameter for a first apparatus may be used for a second apparatus responsive to determining that sensing information associated with both the first and second apparatus satisfies a threshold value. By comparing sensing information associated with both of the first and second apparatus to a threshold value, it may be determined whether values of the parameter for the first and second apparatus are expected to be correlated or sufficiently close to one another such that the value of the parameter for the first apparatus may also be used for the second apparatus. This enables obtaining a value of the parameter for the second apparatus with sufficient accuracy without directly measuring the parameter, which can save resources at the second apparatus and the network device and allow for monitoring the value of the parameter for the second apparatus even when the second apparatus does not have the capability (e.g., functionality, availability or mode) to perform sensing itself. As a result, aspects of the disclosure may be implemented to provide efficient network-wide sensing in heterogenous networks.

In a first aspect, a method is provided. The method involves obtaining sensing information related to a parameter, in which the sensing information is associated with both a first apparatus and a second apparatus. The method also involves, responsive to the sensing information satisfying a threshold value, causing a network device to use, for the second apparatus, one or more measurements of the parameter determined based on one or more first signals transmitted between the first apparatus and the network device.

Causing the network device to use, for the second apparatus, the one or more measurements of the parameter may involve indicating, to the network device, to use the one or more measurements of the parameter for the second apparatus. The method may be performed by one of the first apparatus and the second apparatus. Obtaining the sensing information may involve performing sensing to determine a first relative pose between the first apparatus and the second apparatus.

Performing sensing may involve transmitting one or more second signals towards another of the first apparatus and the second apparatus, receiving a reflected signal comprising a reflection of at least one of the one or more second signals reflected by the other of the first apparatus and the second apparatus and performing one or more measurements on the reflected signal to determine the first relative pose. The one or more second signals may be radio frequency signals. The one or more second signals may include one or more of ultraviolent, visible or near infrared signals. Performing sensing may involve using imaging (e.g., using a camera) in respect of the other of the first apparatus and the second apparatus to determine the first relative pose.

The method may be performed by the first apparatus and the method may also involve performing one or more measurements on one or more reference signals received from the network device to determine the sensing information. Alternatively, the threshold value may be based on one or more measurements performed on one or more reference signals transmitted between the network device and the first apparatus.

The method may be performed by the first apparatus and the method may also involve determining the one or more measurements of the parameter based on the one or more first signals transmitted between the first apparatus and the network device.

The method may also involve determining pose information indicative of a second relative pose between the first apparatus and the second apparatus and causing the network device to use an estimate of the parameter for the second apparatus. The estimate of the parameter for the second apparatus may be based on the pose information and the one or more measurements of the parameter determined based on one or more first signals transmitted between the first apparatus and the network device.

The method may be performed by the network device. Causing the network device to use, for the second apparatus, the one or more measurements of the parameter may involve using, for the second apparatus, the one or more measurements of the parameter determined based on the one or more first signals transmitted between the first apparatus and the network device.

The one or more measurements of the parameter may be one or more first measurements, and obtaining the sensing information may involve determining one or more second measurements of the parameter based on one or more second signals received from the first apparatus, determining one or more third measurements of the parameter based on one or more third signals received from the second apparatus, determining the sensing information based on the one or more second measurements and the one or more third measurements.

The method may further involve obtaining capability information for the first apparatus and the second apparatus and, based on the capability information, indicating to the first apparatus that the one or first signals are to be transmitted between the first apparatus and the network device. The capability information may indicate the capability of the first apparatus and the second apparatus to perform sensing.

The one or more measurements of the parameter determined based on one or more first signals transmitted between the first apparatus and the network device may include a distance between the first apparatus and the network device, a time of flight of the one or more first signals, an angle of arrival of the one or more first signals, an angle of departure of the one or more first signals, a channel subspace for the first apparatus and the network device or an angle between the one or more first signals and one or more other signals between a third apparatus and the network device.

The method may also involve obtaining the threshold value, wherein the threshold value is associated with the parameter.

An apparatus (e.g., an entity) configured to perform the aforementioned method is also provided. In yet another aspect, a memory (e.g., a non-transitory processor-readable medium) is provided. The memory contains instructions (e.g., processor-readable instructions) which, when executed by a processor of an apparatus, cause the apparatus to perform the method described above.

In a second aspect, a method performed by a network device is provided. The method involves receiving an indication, from a first apparatus or a second apparatus, of sensing information related to a parameter satisfying a first threshold value. The sensing information is associated with both the first apparatus and the second apparatus. The method also involves obtaining one or more measurements of the parameter based on one or more first signals transmitted between the first apparatus and the network device, and using the one or more measurements of the parameter for the second apparatus.

The method may also involve obtaining capability information for the first apparatus and the second apparatus and, based on the capability information, indicating to the first apparatus that one or more second signals are to be transmitted between the first apparatus and the network device for one or more further measurements of the parameter. The capability information may indicate a capability of the first apparatus and the second apparatus to perform sensing.

The method may also involve, based on the capability information, configuring one of the first apparatus and the second apparatus to perform sensing in respect of the other of the first apparatus and the second apparatus to determine the sensing information.

Obtaining capability information for the first apparatus and the second apparatus may involve obtaining, for at least one of the first and second apparatus, one or more of: an indication of a functionality of the respective apparatus, an availability of the respective apparatus, and a mode of the respective apparatus.

The method may also involve obtaining a second threshold value indicative of an accuracy requirement for the parameter and sending the first threshold value to at least one of the first apparatus and the second apparatus. The first threshold value may be based on the second threshold value and one or more measurements on one or more reference signals transmitted between the network device and the first apparatus.

Obtaining a second threshold value may involve determining the second threshold value based on one or more of: a target quality of service for the second apparatus, an environment of the second apparatus, and information relating to one or more other apparatus served by the network device.

Obtaining one or more measurements of the parameter based on one or more first signals transmitted between the first apparatus and the network device may involve obtaining one or more measurements of: a range between the first apparatus and the network device, an angle of arrival of the one or more first signals, an angle of departure of the one or more first signals, a channel subspace, or an angle between the one or more first signals and one or more third signals between a third apparatus and the network device.

A network device configured to perform the aforementioned method is also provided. In yet another aspect, a memory (e.g., a non-transitory processor-readable medium) is provided. The memory contains instructions (e.g., processor-readable instructions) which, when executed by a processor of a network device, cause the apparatus to perform the method described above.

In a third aspect, a first apparatus is provided. The first apparatus includes a processor and a memory. The memory stores instructions which, when executed by the processor, cause the first apparatus to obtain sensing information related to a parameter, in which the sensing information is associated with both a second apparatus and a third apparatus. The first apparatus is further caused to, responsive to the sensing information satisfying a threshold value, cause a network device to use, for the third apparatus, one or more measurements of the parameter determined based on one or more first signals transmitted between the second apparatus and the network device.

When the instructions are executed by the processor, the first apparatus may be further caused to cause the network device to use, for the third apparatus, the one or more measurements of the parameter by indicating, to the network device, to use the one or more measurements of the parameter for the third apparatus.

The first apparatus may include one of the second apparatus and the third apparatus. When the instructions are executed by the processor, the first apparatus may be caused to obtain the sensing information by performing sensing to determine a first relative pose between the first apparatus and the second apparatus.

When the instructions are executed by the processor, the first apparatus may be caused to perform the sensing by transmitting one or more second signals towards another of the first apparatus and the second apparatus, receiving a reflected signal comprising a reflection of at least one of the one or more second signals reflected by the other of the first apparatus and the second apparatus, and performing one or more measurements on the reflected signal to determine the first relative pose.

The first apparatus may include the second apparatus. When the instructions are executed by the processor, the first apparatus may be further caused to perform one or more measurements on one or more reference signals received from the network device to determine the sensing information.

The threshold value may be based on one or more measurements performed on one or more reference signals transmitted between the network device and the second apparatus.

The first apparatus may include the second apparatus. When the instructions are executed by the processor, the first apparatus may be further caused to determine the one or more measurements of the parameter based on the one or more first signals transmitted between the second apparatus and the network device.

When the instructions are executed by the processor, the first apparatus may be further caused to determine pose information indicative of a second relative pose between the second apparatus and the third apparatus, and cause the network device to use an estimate of the parameter for the third apparatus. The estimate of the parameter for the third apparatus may be based on the pose information and the one or more measurements of the parameter determined based on one or more first signals transmitted between the second apparatus and the network device.

The first apparatus may include the network device. When the instructions are executed by the processor, the first apparatus may be further caused to cause the network device to use, for the third apparatus, the one or more measurements of the parameter by using, for the third apparatus, the one or more measurements of the parameter determined based on the one or more first signals transmitted between the second apparatus and the network device.

The one or more measurements of the parameter may be one or more first measurements. When the instructions are executed by the processor, the first apparatus may be further caused to obtain the sensing information by determining one or more second measurements of the parameter based on one or more second signals received from the second apparatus, determining one or more third measurements of the parameter based on one or more third signals received from the third apparatus, and determining the sensing information based on the one or more second measurements and the one or more third measurements.

When the instructions are executed by the processor, the first apparatus may be further caused to obtain capability information for the second apparatus and the third apparatus and based on the capability information, indicating to the second apparatus that the one or first signals are to be transmitted between the second apparatus and the network device. The capability information may indicate the capability of the second apparatus and the third apparatus to perform sensing

The one or more measurements of the parameter determined based on one or more first signals transmitted between the second apparatus and the network device may include a distance between the second apparatus and the network device, a time of flight of the one or more first signals, an angle of arrival of the one or more first signals, an angle of departure of the one or more first signals, a channel subspace for the second apparatus and the network device, or an angle between the one or more first signals and one or more other signals between a fourth apparatus and the network device.

When the instructions are executed by the processor, the first apparatus may be further caused to obtain the threshold value, in which the threshold value is associated with the parameter.

In a fourth aspect, a network device is provided. The network device includes a processor and a memory. The memory storing instructions which, when executed by the processor, cause the network device to receive an indication, from a first apparatus or a second apparatus, of sensing information related to a parameter satisfying a first threshold value. The sensing information is associated with both the first apparatus and the second apparatus. The network device is further caused to obtain one or more measurements of the parameter based on one or more first signals transmitted between the first apparatus and the network device, and use the one or more measurements of the parameter for the second apparatus.

When the instructions are executed by the processor, the network device may be further caused to obtain capability information for the first apparatus and the second apparatus, in which the capability information indicates a capability of the first apparatus and the second apparatus to perform sensing. The network device may be further caused to, based on the capability information, indicate to the first apparatus that one or more second signals are to be transmitted between the first apparatus and the network device for one or more further measurements of the parameter.

When the instructions are executed by the processor, the network device may be further caused to based on the capability information, configure one of the first apparatus and the second apparatus to perform sensing in respect of the other of the first apparatus and the second apparatus to determine the sensing information.

When the instructions are executed by the processor, the network device may be caused to obtain capability information for the first apparatus and the second apparatus by obtaining, for at least one of the first and second apparatus, one or more of an indication of a functionality of the respective apparatus, an availability of the respective apparatus, and a mode of the respective apparatus.

When the instructions are executed by the processor, the network device may be further caused to obtain a second threshold value indicative of an accuracy requirement for the parameter and send the first threshold value to at least one of the first apparatus and the second apparatus. The first threshold value may be based on the second threshold value and one or more measurements on one or more reference signals transmitted between the network device and the first apparatus.

When the instructions are executed by the processor, the network device may be caused to obtain a second threshold value by determining the second threshold value based on one or more of: a target quality of service for the second apparatus, an environment of the second apparatus, and information relating to one or more other apparatus served by the network device.

When the instructions are executed by the processor, the network device may be caused to obtain the one or more measurements of the parameter based on the one or more first signals transmitted between the first apparatus and the network device by obtaining one or more measurements of: a range between the first apparatus and the network device, an angle of arrival of the one or more first signals, an angle of departure of the one or more first signals, a channel subspace, and an angle between the one or more first signals and one or more third signals between a third apparatus and the network device.

In another aspect, an apparatus is provided. The apparatus comprises a processor configured to cause the apparatus to perform any of the preceding methods.

In another aspect, a non-transitory computer readable medium is provided. The non-transitory computer readable medium has machine-executable instructions stored thereon, wherein the instructions, when executed by a processing unit of an apparatus, cause the apparatus to perform any of the preceding methods.

In another aspect, a computer program product is provided. The computer program product comprises instructions which, when the program is executed by a computer, cause the computer to perform any of the preceding methods.

In another aspect, a processor of an apparatus is provided. The processor is configured to cause the apparatus to perform any of the preceding methods.

In another aspect, a system comprising a first apparatus, a second apparatus, and a network device is provided. The first apparatus is characterized by sensing information. The sensing information is associated with a first parameter associated with the first apparatus. The second apparatus is also characterized by the sensing information. The sensing information is further associated with a second parameter associated with the second apparatus. The network device is configured to use a measurement of the first parameter for the second apparatus.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur.

FIG. 2 is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5 is a sensing management function in which embodiments of the disclosure may occur.

FIG. 6 shows an example of a system according to embodiments of the disclosure.

FIGS. 7-9 are diagrams illustrating methods according to embodiments of the disclosure.

FIG. 10 shows an example of a system according to embodiments of the disclosure.

FIGS. 11-12 show flowcharts of methods according to embodiments of the disclosure.

### DETAILED DESCRIPTION OF ILLUSTRATIVE EMBODIMENTS

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

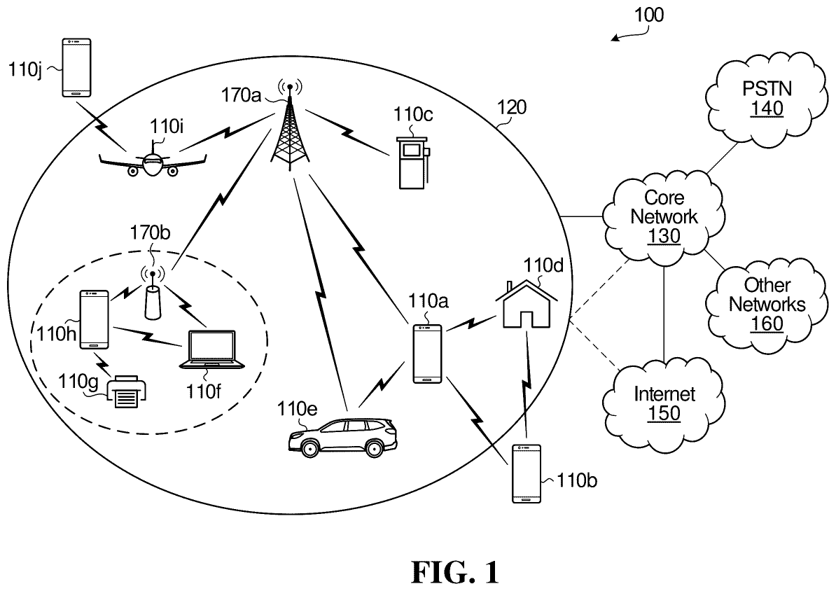

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

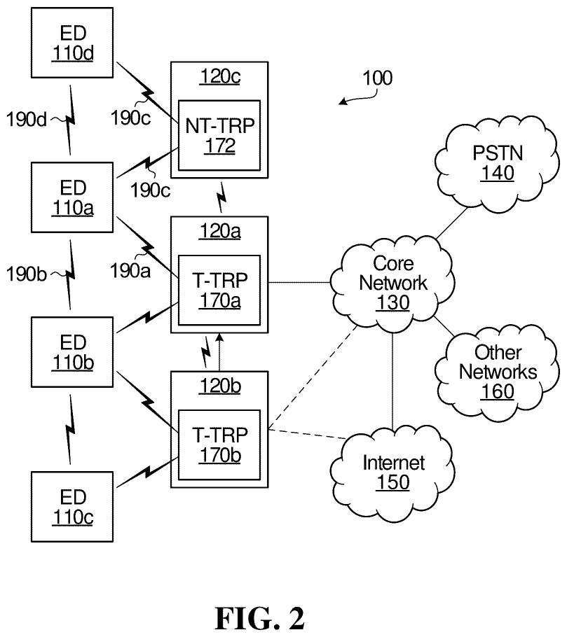

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, and/or the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and/or the like). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (8) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

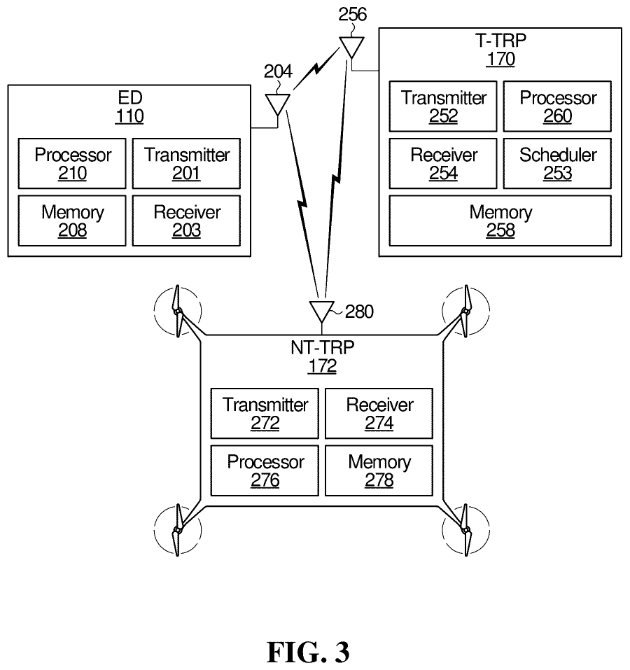

FIG. 3 illustrates another example of an ED 110 and a base station 170a, 170b and/or 170c. The ED 110 is used to connect persons, objects, machines, and/or the like. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, and/or the like.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (for example, established, activated, or enabled), turned-off (for example, released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, and/or the like. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (e.g., scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, and/or the like. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, and/or the like. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

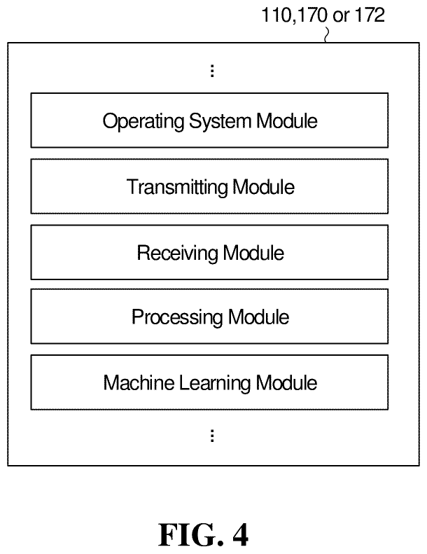

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A sensing system may be used to help gather pose information for a particular apparatus. Pose information may include, for example, relative location of the particular apparatus (e.g., with respect to a reference point or other apparatus), location in a global coordinate system, velocity and direction of movement (relative or in a global coordinate system), orientation information and the information about the wireless environment. In this context, “Location” is also known as “position” and these two terms may be used interchangeably herein. Sensing systems may be particularly useful for obtaining pose information for electronic devices, or ED pose information. ED pose information may be used in cellular communication networks to improve various performance metrics for the network. Such performance metrics may, for example, include capacity, agility and efficiency. The improvement may be achieved when elements of the network exploit the position, the behavior, the mobility pattern, and/or the like, of the ED in the context of a priori information describing a wireless environment in which the ED is operating.

Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of ED pose and environment information is a highly challenging problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and TRPs 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. For example, the system 100 may further include a sensing agent 174, which is an example of a sensing node that is dedicated to sensing. Unlike the EDs 110 and TRPs 170, the sensing agent 174 does not transmit or receive communication signals. However, the sensing agent 174 may communicate configuration information, sensing information, signaling information, or other information within the communication system 100. In some cases, a plurality of sensing agents 174 may be implemented and may communicate with each other to jointly perform a sensing task. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. Reference signal-based techniques may be considered as a type of bi-static (or multi-static) sensing, particularly when measurements of reference signals are used for pose estimation. This type of sensing node may also be known as a node that implements a sensing management function (SMF). In some networks, the SMF may also be known as a node that implements a location management function (LMF). The SMF may be implemented as a physically independent entity located at the core network 130 with connection to the multiple TRPs 170. In other aspects of the present application, the SMF may be implemented as a logical entity co-located inside a TRP, such as the T-TRP 170, through logic carried out by a processor in the TRP, such as the processor 260.

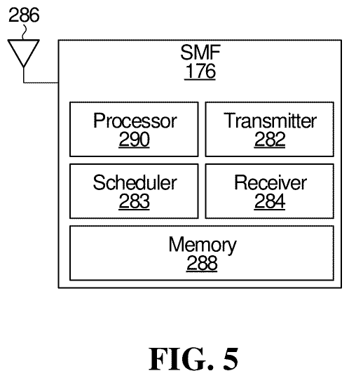

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive and process (or both transmit and receive/process) a signal specific to pose determination process. Positioning techniques based on a global navigation satellite system (GNSS) such as the known Global Positioning System (GPS) are other examples of the active pose estimation paradigm. Various positioning technologies are also known in NR systems and in LTE systems.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining ED channel sub-space information, which is particularly useful for ED channel reconstruction at the sensing node, especially for a beam-based operation and communication. The ED channel sub-space is a subset of the entire algebraic space, defined over the spatial domain, in which the entire channel from the TP to the ED lies. Accordingly, the ED channel sub-space defines the TRP-to-ED channel with very high accuracy. The signals transmitted over other sub-spaces result in a negligible contribution to the ED channel. Knowledge of the ED channel sub-space helps to reduce the effort needed for channel measurement at the ED and channel reconstruction at the network-side. Therefore, the combination of sensing-based techniques and reference signal-based techniques may enable the ED channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (e.g., time, frequency, and/or the like); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Sensing is expected to be a core service in the current and next generation communications system networks. Sensing services may prove to be key enablers for many emerging applications and use cases such as smart cities, cooperative robots, connected vehicles, mixed realities, and remote health-caring.

However, providing high-quality sensing across a communication network risks placing substantial power and hardware requirements for nodes in the network. In practice, different sensing apparatus have different capabilities (e.g., limited power supplies and/or small bandwidths), and may be available for sensing at different times. Methods and apparatus for obtaining high-resolution network-wide sensing information and services for electronic devices and, in particular, for electronic devices with limited power and/or bandwidth, are sought.

According to aspects of the present disclosure, a value of a first parameter for a first electronic device may be used for a second electronic device based on a determination that the values of the first parameter for the first and second electronic devices are expected to be correlated or sufficiently close to one another. A parameter that is expected to be correlated or have a similar value for the first and second electronic device (or, in general, two or more apparatus) may be referred to as a Co-Sensed Parameter (CSP) since sensing in respect of one of the electronic devices to determine the parameter may be used to estimate the parameter in respect of the other electronic device. A CSP may alternatively be referred to as a Quasi Co-Sensed Parameter (QCSP) since the parameter need not take exactly the same value for the first and second electronic device. Rather, the values of the parameter for the first and second device may be correlated or close to one another within a specified tolerance (e.g., as determined by the network or a particular application). Although the parameters are either CSP or they are not (e.g., the determination as to whether parameters are CSP is a binary determination), the degree to which the values of the parameter are required to be correlated or close to one another may vary depending on the application, use case and/or desired accuracy. In some examples, a CSP or QCSP may alternatively be referred to as a Quasi Co-Located (QCL) parameter.

A parameter may be determined to be a CSP by comparing sensing information for the first and second electronic devices to a threshold associated with the parameter. A parameter may be CSP for two electronic devices when measurements of the parameter for the two electronic devices may be mathematically correlated such that estimating the parameter of one electronic device can facilitate estimating the parameter of the other electronic device (e.g., within a particular accuracy). By introducing such a metric, it can be identified whether the parameters of different electronic devices are spatially or temporally correlated such that the estimation (e.g., sensing) of a parameter for one electronic device can be used to estimate the parameter in respect of another electronic device.

In one example, a network may comprise a base station (e.g., a TRP), and many electronic devices with different capabilities that are co-located (e.g., in confined areas). The network may be required to provide sensing services with acceptable accuracy that meets the requirements of different applications and use cases of the electronic devices. For example, one of the electronic devices may be a bus carrying riders having different electronic devices. The base station may provide sensing services in respect of the bus (e.g., monitoring its position and orientation) in addition to providing sensing services in respect of each of the riders' electronic devices. Conventionally, the base station might transmit and/or receive a respective reference signal to each of the riders' electronic devices to monitor their position and orientation. According to the present disclosure, the base station may transmit and/or receive one or more reference signals to the bus, and depending on the correlation or similarity between the parameters of the bus with the parameters of the riders' electronic devices, the base station may use measurements of the one or more reference signals to estimate parameters for some or all of the riders' electronic devices, in addition to the bus. This example may be extended to many practical situations and uses cases such as, for example, a group of moving vehicles (e.g., cars on a highway or flying drones), a group of people in a stadium, and/or the like.

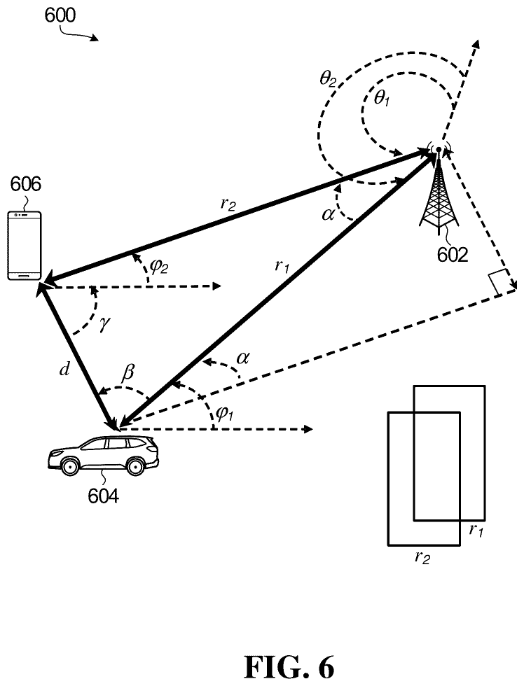

FIG. 6 shows an example of a system 600 according to embodiments of the disclosure. The system 600 includes a network device 602, a first electronic device 604 (ED1) and a second electronic device 606 (ED2).

The network device 602 may be a TRP or a base station, such as any of the TRPs 170 described above in respect of FIGS. 1-4. The first electronic device 604 and the second electronic device 606 may respectively be any suitable electronic device, such as any of the electronic devices 110 described above in respect of FIGS. 1-4. The first and second electronic devices 604, 606 may be sensing nodes. For example, the first and second electronic devices 604, 606 may be equipped with a transmitter, receiver and/or transceiver for backscatter communication. The first and second electronic devices 604, 606 may implement an SMF, such as the SMF 176 described above in respect of FIG. 5, for example. Although FIG. 6 illustrates the first electronic device 604 as being a vehicle (e.g., a car) and the second electronic device 606 as being a handset (e.g., a smartphone or tablet), the present disclosure is not limited as such.

The network device 602 is separated from the first electronic device 604 by a vector r₁ with length r₁. The network device 602 is separated from the second electronic device 606 by a vector r₂ with length r₂. Vectors r₁ and r₂ are represented in the 3-dimensional space in three dimensional Cartesian coordinates (e.g., x, y, and z coordinates), although any suitable coordinate system may be used. Thus, the separations between the network device 602 and the first and second electronic devices 604, 606 are r₁ and r₂, respectively. The separations may be quantified in terms of a distance (e.g., a unit of length) or a signal travel time (e.g., time of flight), for example. The separations r₁ and r₂ may be referred to as the ranges of the first and second electronic devices 604, 606 respectively. The first electronic device 604 is separated from the second electronic device 606 by a vector d (represented in the 3-dimensional space in x, y, and z coordinates) with length d. Thus, the first and second electronic devices 604, 606 have a separation d, which may be expressed as a distance or signal travel time, for example.

However, in some situations, the relative pose between the first and second electronic devices 604, 606 (e.g., the relative position vector) may mean that the range for the first electronic device 604 is a sufficient approximation of the range for the second electronic device (e.g., r₂≈r₁).

In the system 600, the range of the second electronic device 606 may be expressed as

$${r}_{2} = \sqrt{{r}_{1}^{2} + {d}^{2} - 2 {r}_{1} d cos β} , \qquad ( 1 )$$

in which β is the angle between the vectors r₁ and d. The ranges r₁ and r₂ may be said to be similar or highly correlated when

$${d}^{2} - 2 {r}_{1} d cos β ≪ {r}_{1}^{2}$$

This means that a measurement of the range for the first electronic device 602, r₁ may be usable for the second device 604 depending on the values of d, r₁, and β.

In some examples, the measurement of the range for the first electronic device 602 may be used for the second electronic device provided |r₁−r₂|≤δ, in which δ is a threshold (e.g., a desired accuracy or an accuracy requirement) for the range of the first and/or second electronic devices 604, 606. It is possible to reformulate this criterion in terms of d, r₁, and β, so that it can be determined whether r₁ and r₂ are sufficiently similar (e.g., correlated) without directly measuring r₂.

Using a first-order Taylor expansion, the expression for r₂ in Equation (1) may be written as

$${r}_{2} \approx {r}_{1} + \frac{{d}^{2}}{2 {r}_{1}} - d cos β$$

As such, the criterion |r₁−r₂|≤δ may be satisfied when

$$δ \geq \frac{{d}^{2}}{2 {r}_{1}} - d cos β \qquad ( 2 )$$

Therefore, the criterion |r₁−r₂|≤δ may be rewritten in terms of local sensing parameters d, β based on a measurement of the range, r₁, for the first electronic device 602. In this context, a local sensing parameter may be a parameter that is measured, by one electronic device, via performing sensing in respect of another electronic device.

The value of δ may vary depending, on for example, the application (e.g., what the range measurement is intended to be used for) and its required accuracy. In some examples, δ=1 m. In some examples, the value of δ may be based on an accuracy defined in a 3GPP standard. For example, according to Table 7.3.2.2-1 in the 3GPP Technical Specification 22.261 version 16.14.0 Release 16, the horizontal positioning accuracy for outdoor navigation systems is 10 metres. Therefore, in some examples, δ=5 m for outdoor navigation.

Therefore, the ranges for the first and second electronic devices 604, 606 may be determined to be CSP when the criterion in Equation (2) is satisfied. That is, the range for the first electronic device 604 may be used for the second electronic device 606 when the relation in Equation (2) is satisfied.

In some examples, the measurement of the range for the first electronic device 602 may be used for the second electronic device provided

$$1 - ϵ \leq \frac{{r}_{2}}{{r}_{1}} \leq 1 + ϵ ,$$

in which ϵ is a threshold (e.g., a desired accuracy or accuracy requirement) for the range of the first and/or second electronic device 604, 606. It is possible to reformulate this criterion in terms of d, r₁, and β, so that it can be determined whether r₁ and r₂ are sufficiently similar (e.g., correlated) without directly measuring r₂.

As described above, the expression for r₂ in Equation (1) may be written as

$${r}_{2} \approx {r}_{1} + \frac{{d}^{2}}{2 {r}_{1}} - d cos β$$

As such, the criterion

$$1 - ϵ \leq \frac{{r}_{2}}{{r}_{1}} \leq 1 + ϵ$$

may be satisfied when

$$\vert ϵ \vert \geq \frac{{d}^{2}}{2 {r}_{1}^{2}} - \frac{d}{{r}_{1}} cos β = \frac{{X}^{2}}{2} - 2 X cos β \qquad ( 3 )$$

in which

$$X {=}^{△} \frac{d}{{r}_{1}} .$$

Therefore, the ranges for the first and second electronic devices 604, 606 may be determined to be CSP when the criterion in Equation (3) is satisfied. That is, the range for the first electronic device 604 may be used for the second electronic device 606 when the relation in Equation (3) is satisfied.

The quantities d, r₁, and β may be obtained from one or more sensing measurements performed by the network device 602, the first electronic device 604 and/or the second electronic device 606. The skilled person will be familiar with methods for determining d, r₁, and β, so these are not discussed in detail here. Instead, example methods for determining d, r₁, and β are provided as illustration of the types of methods that may be used.

In one example, the first electronic device 604 may transmit one or more first reference signals to the network device 602 and may receive, in response, one or more second reference signals from the network device 602. The first electronic device 604 may determine a round trip travel time based on the time difference between transmitting the one or more first reference signals and receiving the one or more second reference signals, and determine the range, r₁, based on the round trip travel time. In another example, the network device 602 and the first electronic device 604 may be synchronized and the first electronic device 604 may be scheduled to receive one or more reference signals at a time t₁. The first electronic device 604 may determine the time of flight of the one or more reference signals by determining the difference between the time t₁ and the time at which the first electronic device 604 receives the one or more reference signals. In another example, the first electronic device 604 may determine its own position P_{ED} (e.g., using a GNSS sensor at the first electronic device 604) and may obtain an estimate of the position P_{ND} of the network device 602 (e.g., may be received from the network device 602) and may determine the range according to r₁=∥P_{ND}−P_{ED}∥ In some examples, one or more angle measurements (e.g., AoA and/or AoD) may additionally be performed to improve the measurement accuracy of the range, r₁.

The first electronic device 604 may send one or more signals towards the second electronic device 606 and, based on a reflection of one of the signals that is reflected by the second electronic device 606, measure d.

The first electronic device 604 may measure β by measuring the difference between the AoA or AoD of a reference signal sent to or received from the network device 602 with respect to the orientation vector of the electronic first device 604 and the direction of the second electronic device 606 with respect to the orientation vector of the first electronic device 604. The latter angle may be measured during local sensing performed by the first electronic device 604.

These are just some example ways in which the quantities d, r₁, and β may be measured. In general, one or more sensing measurements in respect of the first electronic device 604 and the second electronic device 606 may be used to determine sensing information for comparison to a threshold value. Thus, for the expression given in Equation (2), sensing information including

$$\frac{{d}^{2}}{2 {r}_{1}} - d cos β \qquad ( 4 )$$

may be compared to a threshold δ to determine whether or not measurements of the range for the first electronic device 604 r₁ may be used for the range of the second electronic device 606 r₂. For example, the network device 602 may obtain a measurement of r₁ and assume r₂=r₁ based on determining that the quantity given in Equation (4) satisfies (e.g., is less than) the threshold δ.

It will be appreciated that the criteria in Equations (2) and (3) are specific to the range parameter. Each parameter may have a respective relation for the sensing information to be compared to a respective threshold. As such, the geometric relations, thresholds and parameters described above are provided as examples of how sensing information, such as local sensing information (e.g., based on sensing between the first and second electronic devices 604, 606) may be compared to a threshold relating to a parameter to determine whether the parameter is a CSP for the first and second electronic device 604, 606.

Another example of a parameter which may be determined to be a CSP between the first and second electronic device 604, 606 is the angle between the network device, a respective one of the first and second electronic devices 604, 606 and the other of the first and second electronic devices 604, 606. As illustrated in FIG. 6, the angle between r₂ and d is γ and the angle between r₁ and d is β. γ and β may be determined to be CSP when the ratio between γ and β is almost one. For example, γ and may be determined to be CSP when

$$1 - ϵ \leq \frac{sin γ}{sin β} \leq 1 + ϵ . \qquad ( 5 )$$

Since the angles γ and β are related to one another according to:

$$sin γ = \frac{{r}_{1} sin β}{{r}_{2}} , \qquad ( 6 )$$

γ and β may be determined to be CSP when

$$\frac{{r}_{1}}{{r}_{2}} \leq 1 \pm ϵ . \qquad ( 7 )$$

In general, |ϵ|<1. In some examples, |ϵ|<<1. In some examples, ϵ=0.1. In other examples ϵ=0.01.

Another example of a parameter which may be determined to be a CSP between the first and second electronic devices 604, 606 is the Angle of Departure (AoD) θ₁, θ₂ for signals transmitted from the network device 602 to the first and second electronic devices 604, 606 respectively. As shown in FIG. 6, θ₁ and θ₂ may be related to one another according to

$${θ}_{1} = {θ}_{2} + α , \qquad ( 8 )$$

in which α is the angle between r₁ and r₂. Since a≈d/r₁, Equation (7) may be expressed as:

$$\vert {θ}_{1} - {θ}_{2} \vert \approx d / {r}_{1}$$

The AoD, θ₁ and θ₂, may be determined to be CSP for the first and second electronic devices 604, 606 when |θ₁−θ₂|≤δ_{θ} for a threshold value δ_{θ}. Therefore, the AoD may be determined to be a CSP when

$$\frac{d}{{r}_{1}} \leq {δ}_{θ} . \qquad ( 8 )$$

In another example, the Angle of Arrival (AoA), φ₁, φ₂ for signals received at the first and second electronic devices 604, 606 from the network device 602 may be determined to be a CSP when

$$\frac{d}{{r}_{1}} \leq {δ}_{φ} . \qquad ( 10 )$$

In particular, the AoA for the first electronic device 604, φ₁, may be related to the AoA for the second electronic device, φ₂, according to

$${φ}_{2} = {φ}_{1} - α \approx {φ}_{1} - \frac{d}{{r}_{1}} , \qquad ( 11 )$$

from which the relation in Equation (10) may be derived.

The values of δ_{θ} and δ_{φ} may vary depending, on for example, the application (e.g., what the AoD or AoA measurement is intended to be used for) and its required accuracy. For example, in a MIMO system with a beamwidth (e.g., the width of the beamforming beam) of 10 degrees, δ_{θ}=5 degrees and/or δ_{φ}=5 degrees. This threshold may be used to ensure both electronic devices 604, 606 are covered by the same beam and/or share approximately the same channel subspace.

Range, angle between electronic devices, Angle of Arrival and Angle of Departure are just a few examples of parameters which may be determined to be CSPs. The skilled person will appreciate that there are many parameters for which a value of the parameter for the first electronic device 604 may be used as the value of the parameter for the second electronic device 606 responsive to sensing information for the first and second electronic devices 604, 606 satisfying a threshold value associated with the parameter. In some examples, the parameter may be a sensing parameter such as a pose parameter (e.g., may be indicative of the position and/or movement of the respective electronic device). Examples of parameters which may be CSP thus include range (e.g., time of flight, such as round-trip travel time or delay), angle between electronic devices, Angle of Arrival and Angle of Departure, channel subspace, Doppler shift (e.g., a frequency shift due to relative movement of the respective electronic device), orientation vector and velocity. Channel subspace may comprise a set of angles (e.g., AoD and/or AoA) containing the majority of signal power transmitted from the transmitter (e.g., the network node or the respective electronic device) to the receiver (e.g., the respective electronic device or the network node). It will be appreciated that the parameters mentioned above are examples only and there may be other parameters that may be CSP.

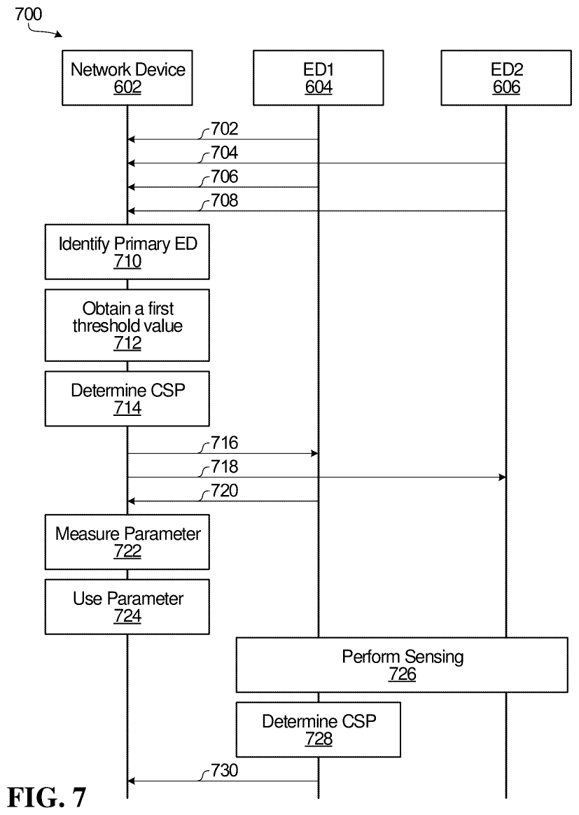

The determination that a parameter is a CSP for the first electronic device 604 and the second electronic device 606 may be made at the network device 602, the first electronic device 604 or the second electronic device 606. This is discussed in more detail below in respect of FIGS. 7-10.

FIG. 7 is a diagram illustrating interrelated methods in an overall method 700, where the interrelated methods are performed by the network device 602, the first electronic device 604, and the second electronic device 606.

The method 700 may begin with the network device receiving, in step 702, first capability information from the first electronic device 604 and receiving, in step 704, second capability information from the second electronic device 606.

The capability information for the first electronic device 604 and the second electronic device 606 indicates a capability of the respective electronic device. The capability of the respective electronic device may indicate, for example, its capability to perform sensing (e.g., in respect of its own parameters and/or the parameters of another electronic device). In this context, capability may comprise one or more of: a functionality of the respective electronic devices, an availability of the respective electronic devices and a mode (e.g., a power mode) of the respective electronic devices. Various examples of functionality, availability and mode are provided below. It will be appreciated that these are not exhaustive and provided by way of example only. As such, other indicators of capability may be used.

The functionality of a respective electronic device may indicate what the electronic device is or may be configured to do. For example, the functionality may indicate a bandwidth (e.g., a transmission bandwidth) of the respective electronic device.

The functionality may include hardware information indicating a type, quantity and/or capacity of hardware at the respective electronic device. The hardware may be any suitable hardware such as, for example, one or more of: one or more sensors (e.g., one or more cameras, one or more RADAR antennas and/or one or more LiDAR sensors), one or more power supplies (e.g., one or more batteries), one or more antennas (e.g., one or more RADAR antennas, one or more transmit antennas, one or more receive antennas and/or one or more transceivers), a memory (e.g., a random access memory), a baseband unit, a radio frequency (RF) unit, and one or more processors (e.g., one or more central processing units and/or one or more graphics processing units). Thus, for example, the functionality may indicate a battery volume (e.g., battery capacity) of the electronic device. In another example, the functionality may indicate a transmission power (e.g., an available transmission power) of the electronic device.

The functionality of the respective electronic device may include a sensing functionality of the electronic device. The sensing functionality of an electronic device may indicate one or more technologies available for sensing at the respective electronic device. The skilled person will appreciate that there are various sensing technologies, such as those discussed above. Examples of sensing technologies include RADAR, LiDAR and imaging (e.g., using one or more cameras) and/or the like. The skilled person will appreciate that the sensing functionality of the respective electronic device may be indicated using hardware information in respect of one or more sensors at the electronic device. For example, the sensing functionality may indicate that there are one or more cameras at the electronic device. Additionally or alternatively, the sensing functionality may indicate the sensing that the electronic device can perform, without any indication of specific hardware. For example, the sensing functionality might indicate that the electronic device can perform imaging without specifying a quantity or type of cameras at the electronic device. The sensing functionality may also include backscatter communication capability of the electronic device and/or a backscatter configuration of the electronic device.

In some examples, the functionality may include a type of processing that the electronic device may be operable to perform. For example, the functionality may include one or more parameters that the electronic device can measure and/or calculate.

The availability of a respective electronic devices may include an availability of hardware at the electronic device, such as any of the hardware described above.

For example, the availability may include an indication of whether or not one or more sensors at the electronic device are in use. In another example, the availability may include a usage of one or more processors at the electronic device. The availability may thus indicate processing resources (e.g., processing power) available at the respective electronic device. In another example, the availability may indicate the memory (e.g., random access memory) usage of the electronic device. In another example, the availability may include a battery usage, a remaining charge of one or more batteries and/or a remaining uptime of the electronic device (e.g., a period of time before the remaining battery power is expended).

The availability may additionally, or alternatively, indicate an availability of one or more logical resources that the electronic device has been configured with. For example, the availability may indicate one or more network resources of the electronic device that are not scheduled for transmissions (e.g., one or more available network resources). The availability may include an available bandwidth of the electronic device, for example. The availability of network resources for the electronic device may indicate that electronic device's availability to report sensing information to the network device 602, for example.

The mode of a respective electronic device may be a connection mode of the respective electronic device, such as a Radio Resource Control (RRC) mode. For example, the mode of a respective electronic device may be one of: an idle mode (e.g., RRC_IDLE), a connected mode (e.g., RRC_CONNECTED) and an inactive mode (e.g., RRC_INACTIVE). In some examples, the mode of a respective electronic device may be a power (or energy usage) mode. Thus, for example, the mode of a respective electronic device may be one of: a power-saving (e.g., low-power) mode or a non-power saving (e.g., normal or high-power) mode.

It will be appreciated that the capability information may indicate the current capability of the respective electronic device (e.g., at or around the time the capability information is determined and/or sent) or an expected capability of the respective electronic device (e.g., at a later time). For example, the electronic device may be scheduled to perform sensing at a later time and may thus indicate, in the capability information, that it will have reduced availability of one or more sensors, one or more processors and/or a power supply at the later time due to the scheduled sensing.

The first and second electronic devices 604, 606 may send the capability information to the network device 602 on request. For example, the network device 602 may send a request for capability information (e.g., may broadcast the request or may send the request to the first and second electronic devices 604, 606 directly) and receive, in response, the capability information from the first and second electronic devices 604, 606.

Alternatively, the first and second electronic devices 604, 606 may send the capability information without receiving an explicit request from the network device 602. For example, the first and second electronic devices 604, 606 may send the capability information to the network device 602 periodically (e.g., at regular intervals). In another example, the first and second electronic devices 604, 606 may send the capability information to the network device 602 responsive to a change in the capability information (e.g., a change that exceeds an associated threshold value). For example, the first electronic device 604 may send capability information to the network device responsive to the available power at the first electronic device 604 falling below a threshold value. The capability information may be sent using static signaling. In some embodiments, the capability information can be sent as part of the general capability report by the electronic devices. The capability information can be sent using dynamic layer 1 signaling. Alternatively, the capability information may be sent using semi-static signaling such as RRC or MAC-CE signaling.

The network device 602 may further receive, in step 706, one or more reference signals from the first electronic device 604. The network device 602 may further receive, in step 708, one or more reference signals from the second electronic device 606. The one or more reference signals may comprise any suitable reference signals such as, for example, one or more of: a sounding reference signal (SRS), a sensing reference signal (SeRS), a demodulation reference signal (DMRS), and a positioning reference signal (PRS). The one or more reference signals received from the first electronic device 604 may be the same type of reference signals received from the second electronic device 606. The one or more reference signals received by the network device 602 in steps 706 and 708 may be referred to as an example of uplink sensing signals.

In step 710, the network device 602 identifies, from the first electronic device 604 and the second electronic device 606, a primary electronic device. The network device 602 identifies the primary electronic device based on the capability information. The network device 602 may thus, based on the capability information, select one of the first and second electronic devices 604, 606 as the primary electronic device.

The electronic device not identified as the primary (e.g., prime) electronic device may be identified as a secondary (e.g., subprime) electronic device. In the illustrated embodiment, the first electronic device 604 is identified as the primary electronic device and the second electronic device 606 is identified as the secondary electronic device.

In this context, a primary electronic device is the electronic device with which the network device 602 will communicate with in order to measure the parameter that is to be used in respect of the primary electronic device and the secondary electronic device. This is described in more detail below in respect of steps 720-724. In contrast, the secondary electronic device might stop or reduce communications with the network device 602 for the purposes of measuring the parameter. As a result, communication resource and power may be saved at the secondary electronic device.

The network device 602 may identify an electronic device as the primary electronic device based on one or more criteria relating to the capability information.

The one or more criteria may specify a desired range of a values (e.g., according to a threshold value) for a functionality parameter or availability parameter of the electronic device. For example, the one or more criteria may specify a minimum battery capacity or availability for the electronic device. Thus, the network device 602 may identify the electronic device with a battery capacity or availability above the minimum battery capacity or availability as the primary electronic device. In another example, the one or more criteria may specify a sensitivity threshold of one or more sensors. Thus, the network device 602 may identify the electronic device with one or more sensors with sensitivity above the minimum sensitivity as the primary electronic device.

The one or more criteria may additionally or alternatively specify a quantity, capacity, and/or type of hardware. For example, the one or more criteria may specify that the primary electronic device is to have a camera.

The one or more criteria may additionally or alternatively specify a required functionality. For example, the one or more criteria may specify that the primary electronic device is operable to perform passive sensing (e.g., RADAR or LiDAR). In another example, the one or more criteria may specify that the primary electronic device is operable to identify one or more apparatus (e.g., other apparatus) in images captured by the primary electronic device (e.g., can perform image detection).

In examples in which more than one electronic device satisfies the one or more criteria, the network device 602 may select any one of the electronic devices satisfying the one or more criteria (e.g., at random or according to one or more further rules).

In some examples, the network device 602 may identify the electronic device with the highest (e.g., most) capability as the primary electronic device. In this context, highest capability may mean the electronic device with a highest functionality or availability parameter, for example. Thus, for example, the network device 602 may identify the electronic device with the largest number of sensing modalities (e.g., RADAR, LiDAR, imaging, and/or the like) as the primary electronic device. In another example, the network device 602 may identify the electronic device with the highest remaining battery as the primary electronic device.

The primary electronic device may, for example, be an electronic device that is capable of performing sensing for its own parameters (e.g., range, angle of arrival and departure, orientation, and/or the like), performing sensing for parameters for other electronic devices and/or environment parameters. The primary electronic device may thus be operable to act as a remote sensory element of the network, in which the primary electronic device can sense its own parameters and any parameters of secondary electronic devices that are determined to be the CSP, and feed them back to the network device 602. The secondary electronic device may be, for example, an electronic device that is not capable performing sensing for a particular parameter or is not available for sensing (e.g., it may be in idle or power saving mode). The secondary electronic device may be equipped with passive component circuitry to enable remote sensing and discovery by primary electronic device through backscatter communication.

In some examples, the secondary electronic device may be capable of performing sensing in respect of the primary electronic device. For example, the primary electronic device may be equipped with passive component circuitry to enable remote sensing and discovery by secondary electronic device through backscatter communication. The secondary electronic device may be configured to perform remote sensing and discovery in respect of the primary electronic device.

In FIG. 7, the step of identifying the primary electronic device 710 is illustrated as being performed after steps 706, 708. In other embodiments, the network device 602 may identify the primary electronic device 710 before receiving sensing signals from one or both of the first electronic device 604 and the second electronic device 606. For example, the network device 602 may identify the primary electronic device 710 responsive to receiving the capability information in steps 702 and/or 704.

In step 712, the network device 602 obtains a first threshold value for a parameter to be determined in respect of the first and second electronic devices 604, 606.

The parameter may be any suitable parameter such as, for example, any of the parameters discussed above in respect of FIG. 6 as examples of parameters which may be determined to be CSP. In some examples, the parameter may be a sensing parameter (e.g., may be determined based on one or more sensing signals). For example, the parameter may be a pose parameter (e.g., may be indicative of the position and/or movement of the respective electronic device).

The first threshold value is associated with (e.g., may be specific to) the parameter. The first threshold value may be a threshold accuracy value for the parameter. The first threshold value may thus indicate a required accuracy for the parameter.

In some examples, the first threshold value may be specific to the second electronic device 606. In particular, the first threshold value may indicate a required accuracy for measurements of the parameter in respect of the second electronic device 606.

In some examples, the first threshold value may be specific to a plurality of electronic devices including the second electronic device. Thus, the first threshold value may be specific to a group of electronic devices.

In some examples, the first threshold value may be specific to a particular region. For example, the first threshold value may be specific to a particular cell or part of a cell. In another example, the first threshold value may be specific to a particular geographical region or feature (e.g., a road or a building). For example, a road may be associated with a higher required accuracy than a forest. In another example, the first threshold value may be specific to a region defined with respect to the primary electronic device (e.g., defined with respect to the first electronic device 604). For example, the first threshold value may be specific to a sphere of radius d_{cl} centered on the first electronic device 604.

In some examples, the first threshold value may be based on the environment of the first electronic device 604 and/or the second electronic device 606 (e.g., based on an environment map). For example, a first environment may be associated with a lower threshold value (e.g., indicating higher accuracy) than a second environment, in which the first environment is more densely populated with electronic devices than the second environment. In another example, an urban environment may be associated with a lower threshold value than a rural environment. In another example, a rich scattering environment may be associated with a lower threshold value than a poor scattering environment. In regions that have a lot of buildings (which may act as reflectors) which are densely packed in a small area, the parameters of different electronic devices may be less correlated even if the electronic devices are in same vicinity. As such, it may be advantageous to use smaller thresholds for such regions.

In some examples, the first threshold value may be based on a quality of service requirement. The quality of service requirement may be based on any combination of the above factors (e.g., the second electronic device 606, region and/or environment, and/or the like).

The first threshold value may be based on information (e.g., feedback) relating to one or more other electronic devices served by the network device 602. The information may be indicative of the environment of the first and/or second electronic devices 604, 606.

The information may comprise a position and/or direction of movement of the one or more electronic devices. In one example, the information may indicate that one or more electronic devices that are currently or were previously being served by the network device 602 travelled in a particular direction. This may indicate that any devices in a similar position are expected to travel in a particular direction for a particular period of time, which may be used to inform the first threshold value. This may arise when, for example, the electronic devices were positioned on a highway, train, or tram, for example.

In another example, a density of electronic devices that are currently or were previously served by the network device 602 may be used to determine the first threshold value. The density of electronic devices may indicate whether or not a particular environment is urban, suburban or rural. For example, first threshold value may be higher in situations in which the density of electronic devices that are currently or were previously served by the network device 602 is higher, than in situations in which the density of electronic devices is or was lower. This may enable, for example, increasing the first threshold value for crowded environments (e.g., busy highways) in which the parameters for lots of electronic devices are likely to be CSPs. In some examples, the information may indicate both a direction of movement and a density of electronic devices. For example, the information may indicate an expected traffic status for the first and/or second electronic devices 604, 606 (e.g., whether or not there is a blockage or traffic jam along their route).

In some examples, the information relating to the one or more other devices may indicate the presence of one or more obstacles that block or reflect signals. For example, the information may indicate the presence of a large building.

The first threshold may be based on or associated with any combination of the aforementioned factors. For example, the first threshold may be smaller for crowded and rich scattering urban environments and larger for lightly crowded and poor scattering suburban environments (e.g., highways, and/or the like).

The network device 602 may receive the first threshold value. For example, the network device 602 may be connected to a node (e.g., a device) in a core network of the system 600 (e.g., such the core network 130) and the network device 602 may receive the first threshold value from the node. Alternatively, the network device 602 may be configured with the first threshold value. In further alternative examples, the network device 602 may determine the first threshold value based on one or more of the factors described in the preceding paragraph.

The network device 602 determines sensing information for the first electronic device 604 and the second electronic device 606. The network device 602 determines the sensing information based on the one or more reference signals received from the first and second electronic devices 604, 606 in steps 706 and 708. The network device 602 may thus perform respective measurements of the parameter for each of the first and second electronic devices 604, 606 on the one or more reference signals to determine the sensing information. The network device 602 may thus, for example, perform one or more measurements on the one or more reference signals received from the first electronic device 604 in step 706 to estimate a value of the parameter for the first electronic device 604 and perform one or more measurements on the one or more reference signals received from the second electronic device 606 in step 708 to estimate a value of the parameter for the second electronic device 606. For example, the network device 602 may measure a first AoA φ₁ for the first electronic device 604 based on the one or more reference signals received in step 706 and a second AoA φ₂ for the second electronic device 606 based on the one or more reference signals received in step 708.

The sensing information may comprise a ratio or difference between the respective measurements for the first and second electronic devices. Thus, representing the measurements for the first electronic device by x₁ and the measurement for the second electronic device by x₂, the sensing information may comprise the ratio x₁/x₂ (or equivalently x₂/x₁) or the difference x₁−x₂ (or equivalently x₂−x₁ or |x₁−x₂|).

In some examples, the network device 602 may perform a plurality of measurements of the parameter for each of the electronic devices 604, 606 based on the sensing signals to obtain respective measurements x₁, x₂. The sensing information may comprise a correlation of the plurality of measurements of the parameter for the first electronic device 604 with the plurality of measurements of the parameter for the second electronic device 606. The correlation may comprise, for example, any suitable correlation coefficient. For example, the correlation may comprise a Pearson correlation coefficient or a Spearman correlation coefficient.

In step 714, the network device 602 determines that the parameter is a CSP for the first and second electronic devices 604, 606 based on a comparison of sensing information to the first threshold value. The network device 602 may thus determine that the parameter is a CSP responsive to the sensing information satisfying the first threshold value. By determining that the parameter is a CSP for the first and second electronic devices 604, 606 in step 714, spatial and/or temporal sensing correlations between electronic devices can be identified.

For example, the network device 602 may determine that the parameter is a CSP based on a difference between measurements of the parameter for the first and second electronic devices, |x₁−x₂|, satisfying (e.g., being less than, or less than or equal to) the first threshold value, δ. The network device 602 may determine that the parameter is a CSP responsive to determining that the following relation is satisfied:

$$\vert {x}_{1} - {x}_{2} \vert \leq δ . \qquad ( 11 )$$

Thus, the network device may determine that a parameter is a CSP responsive to determining that a difference between the parameters is very small.

In other examples, the network device 602 may determine that the parameter is a CSP based on a ratio between measurements of the parameter for the first and second electronic devices satisfying (e.g., being within) a range. For example, the network device 602 may determine that the parameter is a CSP responsive to determining that the following relation is satisfied:

$$1 - ϵ \leq \frac{{x}_{1}}{{x}_{2}} \leq 1 + ϵ , \qquad ( 12 )$$

This may alternatively be expressed as:

$$\frac{{x}_{1}}{{x}_{2}} \leq 1 \pm ϵ$$

Thus, the network device 602 may determine that the parameter is a CSP responsive to the ratio of measurements of the parameter for the electronic devices being almost one. In both expressions, |ϵ|<1. In some examples, |ϵ|<<1. In some examples, ϵ=0.1. In other examples ϵ=0.01. Satisfying a range may alternatively be described as satisfying two threshold values. One threshold value may delimit the lower end of the range and another threshold value may delimit the upper end of the range. Thus, for example shown in Equation (12), the sensing information

$$\frac{{x}_{1}}{{x}_{2}}$$

may be said to satisfy (e.g., exceed) the threshold value 1−ϵ and to satisfy (e.g., be less than or equal to) the threshold value 1+ϵ.

The network device 602 determining that the parameter is a CSP for the first and second electronic devices 604, 606 may alternatively be described as the network device 602 determining that a value of the parameter in respect of the second electronic device 606 may be based on measurements of the parameter in respect of the first electronic device 604. Thus, for example, the network device 602 may determine that the value of the parameter measured for the first electronic device 604 is to be used for the value of the parameter for the second electronic device 606 (e.g., x₂=x₁). The network device 602 may determine that the value of the parameter measured for the first electronic device 604 is to be used for the value of the parameter for the second electronic device 606 as long as the two parameters remain CSP. This is discussed in more detail below under CSP Monitoring. The usage of the parameter is also discussed below in respect of step 724.

In some examples, the network device 602 may assign the first and second electronic devices 604, 606 to a particular group (e.g., the same group). The group may be referred to as a CSP group, for example. The network device 602 may use measurements of the parameter in respect of the first electronic device 604 for all of the devices in the particular group.

In step 716, the network device 602 may send a first sensing configuration to the first electronic device 604. The first sensing configuration may instruct the first electronic device 604 to continue sending one or more reference signals (e.g., such as those transmitted in step 706) to the network device 602 for measurement of the parameter. Instructing the first electronic device 604 to continue sending one or more reference signals to the network device 602 enables the network device 602 to obtain measurements of the parameter in respect of the first electronic device 604 which can then be used in respect of the second electronic device 606. By sending the first sensing configuration to the first electronic device 604, the network device 602 may implicitly indicate to the first electronic device 604 that it is the primary electronic device. In some embodiments, the network device 602 may send an explicit indication to the first electronic device 604 that it is the primary electronic device. The indication may be sent using semi-static signaling. The indication may be sent using medium access control-control element (MAC-CE) or radio resource control (RRC) signaling, for example. Alternatively, the indication may be sent using dynamic signaling such as Li signaling, e.g., through Downlink Control (DCI).

Alternatively, the network device 602 might not instruct the first electronic device 604 to continue sending the one or more reference signals. For example, the first electronic device 604 may already be configured to send the one or more reference signals (e.g., SRS and/or PRS as described above) to the network device 602. The first electronic device 604 may be configured to send the one or more reference signals periodically, at one or more particular times and/or responsive to particular events. As such, the first electronic device 604 may continue reference signals without requiring further instruction from the network device 602.

The network device 602 may, in step 718, send a second sensing configuration to the second electronic device 606. The second sensing configuration may instruct the second electronic device 606 not to send one or more reference signals to the network device 602 for measurement of the parameter. Thus, the second sensing configuration may instruct the electronic device 604 to stop or cease sending reference signals to the network device 602. This may be particularly appropriate in examples in which the second electronic device 606 is otherwise configured to send one or more reference signals to the network device 602. In some examples, the second sensing configuration may configure the second electronic device 606 to send the one or more reference signals less frequently (e.g., with larger intervals between transmissions). Thus, for example, the network device 602 may use measurements of the parameter obtained in respect of the first electronic device 604 for the second device in the intervals between receiving reference signals from the second electronic device 606.

The skilled person will appreciate that instructing the second electronic device 606 not to send the one or more reference signals to the network device 602 for measurement of the parameter might not include instructing the second electronic device not to send any other reference signals. Thus, the second electronic device may not be instructed to stop sending reference signals completely. Instead, the second sensing configuration may instruct the second electronic device 606 to stop sending reference signals to the network device 602 that would be used to determine the parameter.

By sending the second sensing configuration to the second electronic device 606, the network device 602 may implicitly indicate to the second electronic device 660 that it is the secondary electronic device. In some embodiments, the network device 602 may send an explicit indication to the second electronic device 606 that it is the second electronic device. The indication may be sent using semi-static signaling. The indication may be sent using medium access control-control element (MAC-CE) or radio resource control (RRC) signaling, for example. Alternatively, the indication may be sent using dynamic Li signaling such as Li signalling e.g., through DCI.

In step 720, the first electronic device 604 sends one or more reference signals to the network device 602. The first electronic device 604 may send the one or more reference signals to the network device 602 in accordance with the first sensing configuration received in step 716, for example. The one or more reference signals may be the same as the one or more reference signals sent in step 706, for example.

In step 722, the network device 602 determines a value of the parameter for the first electronic device 604 based on the one or more reference signals received in step 720. The network device 602 may thus perform one or more measurements on the one or more signals received in step 720 to determine the second value of the parameter. The nature of the measurements and/or the reference signals may depend on the parameter. For example, the network device may determine a value of the range for the first electronic device (e.g., a value of r₁) by using any of the methods described above in respect of FIG. 6. In another example, the network device 602 may receive the one or more reference signals at a plurality of antenna at the network device 602 and determine a value of the Angle of Arrival for the first electronic device 604 (e.g., a value of ep) based on measurements of the reference signals at the plurality of antenna. The network device 602 may further infer the Angle of Departure for the first electronic device 604 based on the Angle of Arrival, assuming a line of sight connection to the first electronic device 604 and a synchronisation orientation.

In step 724, the network device 602 uses the value of the parameter determined in step 722 as the value of the parameter for the second electronic device 606. As the method described herein may be applied in respect of many different parameters, the skilled person will appreciate that the way in which the parameters may be used may vary. For example, the network device 602 may use the range of the first electronic device 604 to estimate the position of the second electronic device 606. In another example, the network device 602 may determine the time of flight of the second electronic device 606 using the range of the first electronic device 604. The time of flight of the second electronic device 606 may be used for synchronisation of the second electronic device 606. In another example, the network device 602 may determine a transmission power for the second electronic device 606 based on the range of the first electronic device 604. In another example, AoA and/or AoD for the first electronic device 604 may be used to facilitate beamforming for the second electronic device 606. This may reduce or eliminate the need to perform beamforming for the second electronic device.

According to the method 700, the network device 602 may, based on a determination that the parameter is a CSP for the first and second electronic devices 604, 606, determine that measurements of the parameter for the first electronic device 604 may also be used for the second electronic device 606. This can reduce the uplink signals transmitted by the second electronic device 606, saving signaling resources and power at the second electronic device 606, whilst still allowing sensing services to be provided in respect of the second electronic device 606.

Steps 720-724 may be repeated one or more times. Thus, the network device 602 may continue using measurements of the parameter for the first electronic device 604 for the second electronic device 606. For example, the network device 602 may continue using measurements of the parameter for the first electronic device 604 for the second electronic device 606 until the second electronic device 606 disconnects from (e.g., is no longer served by) the network device 602.

### CSP Monitoring

In some examples, it may be redetermined (e.g., at a later point in time) whether or not the parameter is a CSP for the first and second electronic devices 604, 606. For example, the network device 602 may instruct the second electronic device 606 to send one or more reference signals to the network device 602 to enable step 714 to be repeated. The network device 602 may send the instruction in the second sensing configurations. For example, the second sensing configuration may indicate that the second electronic device 606 is to continue sending reference signals to the network device 602, but at a reduced frequency. In another example, the second sensing configuration may indicate that the second electronic device 606 is to send one or more reference signals to the network device 602 at a particular time (e.g., after a particular time period has elapsed).

Responsive to redetermining that the parameter is a CSP based on the one or more reference signals received from the second electronic device 606, steps 720-724 may be repeated such that the network device 602 can continue using measurements of the parameter for the first electronic device 604 for the second electronic device 606. The network device 602 may send further sensing configurations to the first and/or second electronic devices 604, 606 (e.g., the network device 602 may repeat step 716 and/or step 718).

Alternatively, one or more of the first electronic device 604 and the second electronic device 606 may perform sensing to monitor whether the parameter is still CSP for the first and second electronic devices 604, 606. Thus, rather than repeating step 714 at the network device 602, local sensing may be performed by at least one of the first and second electronic devices 604, 606. The network device 602 may configure the first and/or second electronic devices 604, 606 to perform local sensing in the first and/or second sensing configurations sent in steps 716 and 718 respectively.

This may be illustrated by considering an example in which, in step 714, the AoD is determined to be CSP for the first and second electronic devices 604, 606. Thus, it may be determined in step 714 that |θ₁−θ₂|≤δ₁ for a first threshold δ₁. As described above in respect of FIG. 6, this criterion may alternatively be expressed as

$$\frac{d}{{r}_{1}} \leq {δ}_{1} ,$$

in which d is the separation (e.g., quantified in terms of a distance using a unit of length or a signal travel time) between the first and second electronic devices 604, 606 and the r₁ is the range of the first electronic device 604. As the range of the first electronic device 604 may be known to the network device 602 and the first electronic device 604 can perform sensing to determine the separation between the first and second electronic devices 604, 606, the network device 602 may configure the first electronic device 604 with a second threshold value δ₂=r₁δ₁ for comparison with measurements of the separation d determined by the first electronic device 604. The first electronic device 604 may determine the AoD is still a CSP responsive to the separation satisfying (e.g., being less than) the second threshold.

The sensing performed by the first electronic device 604 to determine the separation may be passive. Thus, the second electronic device 606 might not take part in the process to determine the separation. For example, the first electronic device 604 may send one or more signals (e.g., radio signals) towards the second electronic device 606 and, based on a reflection of one of the signals that is reflected by the second electronic device 606, measure d. For example, the first electronic device 604 may broadcast a single-tone sinusoidal continuous wave and receive one or more reflections of the broadcasted wave, reflected by the second electronic device 606. In another example, the first electronic device 604 may broadcast a frequency modulated continuous wave (FMCW), or a chirp signal and receive one or more reflections of the broadcasted wave, reflected by the second electronic device 606. In some embodiments, the first electronic device 604 may determine the separation d and the identity of the second electronic device 606 based on backscatter communication in which the second electronic device embed its identity in a reflected RF signal (e.g., using passive component circuitry at the second electronic device 606).

Alternatively, the sensing performed to determine the separation may be active. Thus, the first and second electronic devices 606 may both be involved in the sensing. The first electronic device 604 may, for example, determine the separation d by transmitting a first signal to the second electronic device 606 and receiving, in response a second signal. The first and/or second signals might or might not comprise one or more reference signals. The first and/or second signals may be sensing signals.

Although this example is described in the context of AoD being the CSP, the skilled person will appreciate that similar approaches may be applied to any parameter which may be determined to be a CSP for the first and second electronic devices 604, 606. The calculation of the second threshold value, δ₂, based on the first threshold, δ₁, may depend on the particular parameter.

Thus, in general, the network device 602 may determine a second threshold value based on the first threshold value and sensing information based on measurements of one or more reference signals transmitted between the network device 602 and the first electronic device 604. The measurements of the one or more reference signals may be indicative of a pose (e.g., position, including angle, and/or velocity) of the first electronic device 604 relative to the network device 602.

Thus, one or more of the first electronic device 604 and the second electronic device 606 may perform sensing to monitor whether the parameter is (e.g., continues to be) a CSP for the first and second electronic devices 604, 606.

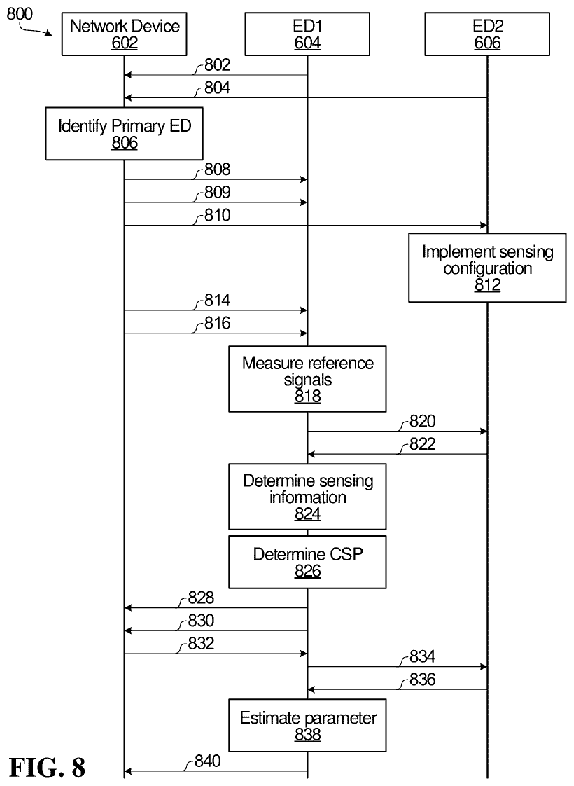

Returning to the method 700, the network device 602 may configure one or more of the first and second electronic devices 604, 606 may perform sensing to monitor whether the parameter is a CSP. This may be included in the first and/or second sensing configuration sent in steps 716 and 718 or it might be sent in a different message. The network device 602 may additionally send the second threshold value to the first electronic device 602 and/or identifiers for the first and/or second electronic devices 604, 606 to the one or more of the first and second electronic devices 604, 606. The configuration of one or both of the electronic devices 604, 606 to perform this sensing is described in more detail in respect of FIGS. 7 and 8.

In step 726, one or more of the first and second electronic devices 604, 606 may perform sensing in respect of the first and second electronic devices 604, 606 to determine second sensing information. The second sensing information may comprise, for example, one or more of: the separation between the first and second electronic devices 604, 606 (e.g., to determine whether the AoD or AoA is a CSP), the relative Doppler frequency between the first and second electronic devices 604, 606 and the relative angle between the first and second electronic devices 604, 606.

In step 728, the first electronic device 604 compares the second sensing information to the second threshold value to determine whether or not the parameter is still CSP.

Responsive to the second sensing information failing to satisfy the second threshold value (e.g., the separation d exceeding the second threshold value, d>δ₂), the first electronic device 604 may, in step 730, notify the network device 602 that the parameter is no longer a CSP for the first and second electronic devices 604, 606. Alternatively, the first electronic device 604 may determine that the measurement of the second sensing information satisfies the second threshold value (e.g., d≤δ₂) and the first electronic device 604 may, in step 730, notify the network device 602 that the parameter is a CSP for the first and second electronic devices 604, 606. In some examples, the first electronic device might not explicitly notify the network device 602 that the parameter is still a CSP. For example, the network device 602 may assume the lack of a notification means the parameter is still CSP. As such, step 730 may be omitted in some examples.

Although the foregoing description of steps 726-730 refers to steps 728 and 730 being performed by the first electronic device 604, the skilled person will appreciate that in other embodiments, steps 728 and 730 may be performed by the second electronic device 606. Thus, the second electronic device 606 may determine the second sensing information based on the sensing performed in step 726 and perform steps 728 and 730 accordingly.

### Downlink Parameter Measurement

In the above description of the method 700, downlink reference signals are used for determining a value of the parameter. In other embodiments, uplink reference signals may be used.

In particular, instead of reference signals being transmitted from the first and second electronic devices 604, 606 to the network device 602 in steps 706 and 708, the network device 602 may transmit one or more reference signals to the first and second electronic devices 604, 606 and the first and second electronic devices 604, 606 may perform measurements on the respective reference signals to estimate respective values of the parameter. The first and second electronic devices 604, 606 may transmit the estimated values to the network device 602. The network device 602 may determine the sensing information based on the received estimated values (e.g., by determining a ratio or difference between the received estimated values).

In some embodiments, the second sensing configuration described above in respect of 718 may further instruct the second electronic device 606 not to measure one or more reference signals transmitted by the network node 602 for measurement of the parameter. This may be particularly appropriate in examples in which the second electronic device 606 is otherwise configured to perform measurements on one or more reference signals received from the network device 602. For example, the second electronic device 606 may be configured to perform measurements periodically, or on one or more reference signals received from the network device 602 in one or more time slots. As such, the network device 602 may, using the second sensing configuration, configure the second electronic device 606 to stop performing measurements on the one or more reference signals received from the network node 602 to determine the parameter. The second sensing configuration may instruct the second electronic device 606 not to receive, process and/or measure reference signals received from the network device 602. This may reduce measurement overhead for the second electronic device 606.

In some embodiments, steps 720 and 722 of the method 700 may be replaced by steps in which the network device 602 sends the one or more reference signals to the first electronic device 604. The first electronic device 604 may determine a value of the parameter based on the one or more reference signals (e.g., as described in step 722, but performed by the first electronic device 604). The first electronic device 604 may transmit the value to the network device 602. The network device may use the received value of the parameter in step 724 as described above.

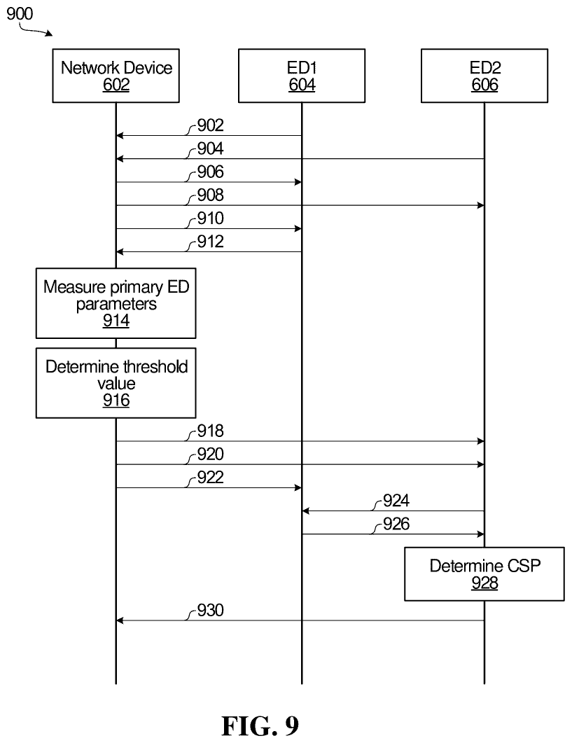

In the method 700, the network device 602 identifies the first electronic device as primary electronic device in step 710 and determines the parameter is a CSP in step 714. In other embodiments, the determination that the parameter is a CSP for the first and second electronic devices 604, 606 may be performed elsewhere. This is described in detail with respect to FIGS. 8 and 9.

### Primary Electronic Device-Based Sensing

FIG. 8 is a diagram illustrating interrelated methods in an overall method 800, where the interrelated methods are performed by the network device 602, the first electronic device 604, and the second electronic device 606. Although the method 800 is an alternative to the method 700, the skilled person will appreciate that one or more steps of the method 700 may be implemented in the method 800 and vice-versa.

The method 800 may begin with, in steps 802 and 804, the network device receiving first capability information from the first electronic device 604 and receiving second capability information from the second electronic device 606. Steps 802 and 804 may be performed in the same manner as steps 702 and 704 described above in respect of FIG. 7.

In step 806, the network device 602 identifies the first electronic device 604 as the primary (e.g., prime) electronic device and the second electronic device 606 as the secondary (e.g., subprime) electronic device. Step 806 may be performed in the same manner as step 706 described above in respect of FIG. 7.

In step 808, the network device 602 indicates, to the first electronic device 604 that it is the primary electronic device. The indication may be sent using semi-static signaling. The indication may be sent using medium access control-control element (MAC-CE) or radio resource control (RRC) signaling, for example. Alternatively, the indication may be sent using dynamic Li signaling, e.g., through DCI.

By indicating to the first electronic device 604 that it is the primary electronic device, the network device 602 may indicate that a first value of the parameter is to be measured for the first electronic device 604 and the first value of the parameter may be used (e.g., by the network device 602) for one or more other electronic devices (e.g., for the second electronic device 606). As described below in more detail, in this embodiment the first electronic device 604 determines the first value of the parameter by performing one or more measurements on one or more reference signals received from the network device 602. As such, the indication sent in step 808 may indicate that the first electronic device 604 is to perform the one or more measurements to determine the first value of the parameter. In other embodiments, the first value of the parameter may be determined by the network device 602 measuring one or more reference signals received from the first electronic device (e.g., as in the method 700) and the network device 602 may, in step 808, indicate to the first electronic device 604 to send one or more reference signals to the network device 602 for measurement of the parameter.

In step 809, the network device 602 sends a first sensing configuration to the first electronic device 604. The first sensing configuration may be sent using semi-static signaling. The first sensing configuration may be sent using medium access control-control element (MAC-CE) or radio resource control (RRC) signaling, for example. The network device 602 may send the first sensing configuration and the indication that the first electronic device 604 is the primary electronic device in the same message or different messages.

The first sensing configuration configures the first electronic device 604 to perform passive sensing to detect the second electronic device 606. In particular, the first sensing configuration configures the first electronic device 604 to transmit one or more sensing signals such that at least one of the sensing signals might be reflected by the second electronic device 606. By detecting the reflected signal, the first electronic device 604 can detect the presence of the second electronic device 606. The network device may thus, in step 808, configure the first electronic device to use backscattering communications to identify other electronic devices, such as the second electronic device 606.

The first sensing configuration may specify one or more properties of the sensing signals such as one or more of: a transmission power, a frequency or bandwidth, a sensing waveform, one or more waveform parameter and one or more parameters to be sensed. The first sensing configuration may, additionally or alternatively, specify a backscatter communication configuration such as one or more of: an identifier of the second electronic device 606, a transmission power, a frequency, and/or a communication and/or scanning period.

The first sensing configuration may configure the first electronic device 604 to broadcast the one or more sensing signals. This may be particularly appropriate in examples in which the first electronic device 604 is not aware of the location of the second electronic device 606. For example, the first sensing configuration may configure the first electronic device 604 to broadcast a single-tone sinusoidal continuous wave, a frequency modulated continuous wave (FMCW) signal or a chirp. In some examples, the first electronic device 604 may be provided with a location (such as an estimated or an approximate location) of the second electronic device 606 (e.g., by the network device 602) and the first electronic device 604 may send the one or more signals towards the provided location. The first electronic device 604 may thus, for example, transmit the one or more sensing signals using one or more beams, in which the one or more beams are determined (e.g., selected from a plurality of beams) based on the location of the second electronic device 606.

The one or more sensing signals may be RF sensing signals, for example. Thus, the first sensing configuration may configure the first electronic device 604 to detect the second electronic device 606 using RADAR.

In step 810, the network device 602 sends a second sensing configuration to the second electronic device 606. The second sensing configuration may be sent using semi-static signaling. The second sensing configuration may be sent using medium access control-control element (MAC-CE) or radio resource control (RRC) signaling, for example.

In step 812, the second electronic device 606 implements the second sensing configuration. The second sensing configuration configures the second electronic device 606 to embed an identifier for the second electronic device 606 in any sensing signal reflected by the second electronic device 606. The second electronic device 606 may be configured to embed the identifier using any technology for changing a property of a reflected signal in a deterministic way. Thus, the second electronic device 606 may be configured to modulate an incident signal according to its identifier (e.g., an assigned identifier). The second electronic device 606 may, for example, comprise passive component circuitry that can change an incident wave and embed the identifier in the reflected wave (e.g., through backscattering).

Embedding an identifier in the reflected signal allows the first electronic device 604 to distinguish between signals reflected by second electronic device 606 and signals reflected by other features in the environment (e.g., obstacles or other electronic devices). The identifier may be any suitable identifier such as, for example, a Radio Network Temporary Identifier (RNTI). The second sensing configuration may additionally configure the second electronic device 606 to modulate and send (e.g., reflect) the incident signal back to the first electronic device 604. The network device 602 may thus, in step 810, configure the second electronic device 660 to turn on (e.g., activate) passive sensing.

The network device 602 may obtain a first threshold value for the parameter to be determined in respect of the first and second electronic devices 604, 606 (not illustrated). The first threshold value may be the same as the first threshold value discussed above in respect of the method 700. This operation may be performed in accordance with step 712 described above in respect of FIG. 7.

In step 814, the network device 602 may send the first threshold value to the first electronic device 604. The first threshold value may be sent using semi-static signaling. The first threshold value may be sent using medium access control-control element (MAC-CE) or radio resource control (RRC) signaling, for example. In some examples, the first threshold value may be sent using dynamic signaling such as Layer 1 signaling, for example through DCI.

By obtaining the first threshold value at the network device 602, the first threshold value can be adapted for the second electronic device 606. In particular, the network (e.g., the network device 602 or another node connected to the network device 602) may be aware of one or more of the factors upon which the first threshold value may be based that are discussed above in respect of the method 700 (e.g., a target quality of service for the second electronic device 604, the environment of the second electronic device 604, and information relating to another apparatus served by the network device 602) and may determine the first threshold value based on one or more of these factors.

Alternatively, the first electronic device 604 may be preconfigured with the first threshold value. The first electronic device 604 may, responsive to receiving the indication that it is the primary electronic device in step 808, retrieve the first threshold value from a memory (e.g., a non-transitory processor-readable medium) at the first electronic device 604. In some examples, the first electronic device 604 may be configured with respective threshold values for a plurality of parameters. For example, the first electronic device 604 may be configured with a first threshold value of δ₁=5 m for the range and another first threshold value of δ₁=5 degrees for AoA. The skilled person will appreciate that different parameters may have different tolerances (e.g., different required accuracies).

In step 816, the network device 602 sends one or more reference signals to the first electronic device 604. The one or more reference signals may comprise any suitable downlink reference signals (DL-RSs) such as one or more of: DMRS, Phase Tracking Reference Signal (PTRS), Channel State Information Reference Signal (CSI-RS), PRS, and SeRS. The one or more reference signals may be any suitable RAN1 reference signals, for example.

In step 818, the first electronic device 602 performs one or more measurements on the reference signals received in step 816. Based on the one or more measurements, the first electronic device 604 may determine a first value of the parameter. This enables obtaining high-resolution measurements of the parameter. The first electronic device 604 may use any of the methods for determining parameters based on reference signals described herein.

In step 820, the first electronic device 604 sends one or more sensing signals in accordance with the first sensing configuration. In step 822, the first electronic device 604 receives a reflection of one of the sensing signals that is reflected by the second electronic device 606. The identifier of the second electronic device 606 is embedded in the reflected signal.

In step 824, the first electronic device 604 determines combined sensing information based on the measurements of the one or more reference signals from step 814 and the reflected signal received in step 822. In particular, the first electronic device 604 may use the measurements of the one or more reference signals to determine first sensing information in respect of the first electronic device 604 and the network device 602. The first electronic device 604 may use the measurements of the reflected signal to determine second sensing information in respect of the first electronic device 604 and the second electronic device 606.

The first sensing information may be indicative of the pose of the first electronic device 604 relative to the network device 602. The first sensing information may thus be referred to as first pose information. The first sensing information may include, for example, one or more of: the range, AoA, AoD, and velocity of the first electronic device. The velocity may be the relative velocity (e.g., speed or speed and direction of movement) of the first electronic device 604 with respect to the network device 602. The first sensing information may include, for example, the first value of the parameter.

The second sensing information may be indicative of the pose of the second electronic device 606 relative to the first electronic device 604. The second sensing information may include, for example, one or more of: the separation between the first and second electronic devices 604, 606 (e.g., distance or signal travel time, such as round-trip travel time), the angle between the first and second electronic devices 604, 606 (e.g., β) and a relative velocity (e.g., speed or speed and direction of movement) of the second electronic device 606 with respect to the first electronic device 604.

The nature of the combined sensing information determined in step 824 may depend on the parameter which is to be determined for the first and second electronic devices 604, 606. In one example, the parameter may be the range and the combined sensing information may be calculated according to:

$$\frac{{d}^{2}}{2 {r}_{1}} - d cos ( β )$$

in which r₁ may be determined based on the measurements of the one or more reference signals, d may be based on the measurements of the reflected signal and β may be based on both the measurements of the one or more reference signals and the measurements of the reflected signal.

In another example, the parameter may be the AoD, and the combined sensing information may be calculated according to d/r₁. In another example, the parameter may be the AoA, and the combined sensing information may be calculated according to d/r₁.

In step 826, the first electronic device 604 compares the combined sensing information to the first threshold value to determine whether or not the parameter is a CSP. The first electronic device 604 may determine that the parameter is a CSP responsive to the sensing information satisfying the first threshold value. In some examples, the first threshold value may indicate a maximum value. Thus, the first electronic device 604 may determine that the parameter is a CSP responsive to the sensing information being less the first threshold value. Step 826 may be performed in accordance with step 714 described above, with the combined sensing information taking the place of the sensing information referred to in the description of FIG. 7. By determining that the parameter is a CSP for the first and second electronic devices 604, 606 in step 826, spatial and/or temporal sensing correlations between electronic devices can be identified.

Alternatively, the first electronic device 604 may, in step 824, determine a second threshold value based on the first threshold value and the first sensing information and, in step 826, compare the second sensing information to the second threshold value to determine whether or not the parameter is a CSP. The second threshold value may thus be determined in a similar manner to the second threshold value discussed above in respect of the method 700.

For example, the first electronic device may determine a second threshold value δ₂=r₁δ₁ based on the range of the first electronic device (an example of first sensing information) and the first threshold value δ₁. The first electronic device may compare the separation d (an example of second sensing information) to the second threshold value to determine whether or not the parameter is a CSP.

In step 828, the first electronic device 604 indicates to the network device 602 that the parameter is a CSP for the first and second electronic devices 604, 606. The first electronic device 604 may indicate this to the network device 602 by sending the identifier for the second electronic device 606 to the network device 602. The identifier may be sent over a physical uplink shared channel (PUSCH), for example. The first electronic device 604 may thus indicate, in step 828, that the network device 602 is to use, for the second electronic device 604, one or more measurements of the parameter determined based on one or more first signals transmitted between the first electronic device 604 and the network device 602.

The first electronic device 604 may additionally send one or more of: the first sensing information, the second sensing information and/or the combined sensing information to the network device 602. This information may be sent in the same message or a different message to the indication that the parameter is a CSP. This information may be sent over the PUSCH, for example.

In step 830, the first electronic device 604 sends the value of the parameter determined in step 814 to the network device 602. The first electronic device 604 may thus report the parameter measured based on the one or more reference signals received from the network device 602. The electronic device 606 may send the value to the network device 602 using a PUSCH.

In some examples, the value of the parameter and the indication that the parameter is a CSP for the first and second electronic devices 604, 606 may be sent in the same message. For example, the first electronic device 604 may send a message include the value of the parameter and the identifier for the second electronic device 606. By including these in the same message, the first electronic device 604 may indicate to the network device 602 that the parameter is a CSP for the first and second electronic devices 604, 606 without needing to include an explicit indicator (e.g., a flag) in the message.

The network device 602 may, responsive to receiving the indication that the parameter is a CSP for the first and second electronic devices 604, 606 received in step 828, use the value of the parameter for both the first and second electronic devices 604, 606. The network device 602 may use the parameter in the same or similar manner to step 724 described above in respect of FIG. 7, for example.

Steps 816-830 may be repeated one or more times. Thus, the first electronic device 604 may determine one or more second values of the parameter and report the second values to the network device 602. The first electronic device 604 may perform sensing to monitor whether or not the parameter is still CSP for the first and second electronic devices 604, 606. The first electronic device may be configured to perform steps 816-830 periodically, at one or more particular times and/or responsive to particular events. This monitoring may be performed in accordance with steps 726-730 described above, for example. Similarly, steps 820-830 or 818-830 may be implemented in the method 700 (e.g., instead of steps 726-730).

In some examples, the first electronic device 604 may determine, in step 826, that the parameter is not CSP for the first and second electronic devices 604, 606. This determination may be made on the first iteration of step 826 or on a subsequent iteration. The first electronic device 604 may notify the network device 602 that the parameter is not CSP (e.g., as described above in respect of step 730).

### Finer Sensing

In some embodiments, the sensing performed by the first electronic device 604 in respect of the second electronic device 606 may be used to estimate a value of the parameter for the second electronic device 606. This may be particularly advantageous when the parameter needs to be determined for the second electronic device 606 to a high accuracy but the second electronic device 606 has limited sensing capability (e.g., has limited availability, power and/or functionality).

The first electronic device 604 may determine an estimate of the parameter for the second electronic device 606 based on the first value of the parameter (e.g., measured in respect of the first electronic device 604) and one or more measurements of the pose (e.g., location) of the second electronic device 606 relative to the first electronic device 604. The one or more pose measurements may be based on the reflected signal received in step 822. Alternatively, the first electronic device 604 may perform additional sensing to determine the one or more pose measurements. An example of implementation of this is described in respect of steps 832-836 shown in FIG. 8. Although this is described in the context of the method 800, the skilled person will appreciate that the method 800 may alternatively be performed in the absence of one or more of steps 832-836. In addition, the steps 832-836 may also be implemented in other methods described herein (e.g., method 700 described above and/or method 900 described below).

In step 832, the network device 602 sends a request to the first electronic device 604 to perform enhanced (e.g., finer) sensing in respect of the second electronic device 606. The request may be sent using dynamic RAN1 signaling, for example. In this context, the sensing is referred to as enhanced or finer since it is expected to yield a more accurate estimate of the parameter for the second electronic device 606 than would be achieved by assuming the parameter measured in respect of the first electronic device 604 can also be used for the second electronic device 606. The request may alternatively be referred to as a request for additional sensing.

In step 834, the first electronic device 604 sends one or more sensing signals and receives, in step 836 a reflection of one of the sensing signals that is reflected by the second electronic device 606. Steps 834 and 836 may be performed in accordance with steps 820 and 822, for example. The one or more sensing signals may comprise RF signals. The sensing performed in steps 834 and 836 may, for example, comprise RADAR. In some examples, the sensing performed in steps 834 and 836 may be monostatic. Thus, the first electronic device 604 may send the one or more sensing signals with a transmitter that is co-located with the receiver that receives the reflected signal. The transmitter and the receiver may be integrated in a transceiver, for example.

In particular examples, the first electronic device 604 may send the one or more sensing signals using beamforming. Thus, the first electronic device 604 may transmit the one or more sensing signals using one or more beams specifically target at the second electronic device 606. The first electronic device 604 may determine the one or more beams based on the location of the second electronic device 606. The first electronic device 604 may receive the location of the second electronic device 606 from the network device 602. Alternatively, the first electronic device 604 may determine the location of the second electronic device 606 using any suitable method such as, for example, using sensing (e.g., the sensing described above in respect of steps 820-822).

In step 838, the first electronic device 604 determines an estimate of the parameter for the second electronic device 606 based on the first value of the parameter (e.g., measured in respect of the first electronic device 604) and the reflected signal. The first electronic device 604 may thus determine one or more measurements of the pose (e.g., location, velocity, and/or the like) of the second electronic device 606 relative to the first electronic device 604 based on the reflected signal and use the relative pose measurements to estimate the parameter for the second electronic device 606.

In one example, the first electronic device 604 may determine the separation, d, and the relative angle, β=θ−γ, based on the reflected signal. The first electronic device 604 may use the separation and relative angle, together with the range of the first electronic device 604 (e.g., as determined in step 818), to determine the range of the second electronic device 606 according to:

$${r}_{2} = \sqrt{{r}_{1}^{2} + {d}^{2} - 2 {r}_{1} d cos β} .$$

In another example, the first electronic device 604 may determine the separation, d, based on the reflected signal. The first electronic device 604 may determine its AoA, φ₁, and range, r₁, based on the reference signals received in step 816. The first electronic device 604 may estimate the AoA for the second electronic device according to:

$${φ}_{2} = {φ}_{1} - \frac{d}{{r}_{1}} .$$

In another example, the first electronic device 604 may determine the separation, d, based on the reflected signal. The first electronic device 604 may determine its AoD, θ₁, and range, r₁, based on the reference signals received in step 816. The first electronic device 604 may estimate the Angle of Departure for the second electronic device according to:

$${θ}_{2} = {θ}_{1} - \frac{d}{{r}_{1}} .$$

In step 840, the first electronic device 604 sends the estimate of the parameter for the second electronic device 606 to the network device 602. For example, the first electronic device 604 may send the estimate of the range, r₂, for the second electronic device 606 to the network device 602. The first electronic device 604 may also send the identifier for the second electronic device 606 to the network device 602 (e.g., in the same or different message as the estimate). The estimate and/or the identifier may be sent using a physical uplink shared channel (PUSCH), for example.

Thus the first electronic device 604 may estimate the parameter for the second electronic device 606 based on the reflected signal and send the estimate to the network device 602. In other examples, the estimation of the parameter for the second electronic device 606 may be implemented at the network device 602. For example, the first electronic device 604 may, instead of performing steps 838 and 840, determine one or more measurements of the pose (e.g., location) of the second electronic device 606 relative to the first electronic device 604 based on the reflected signal and send the one or more relative pose measurements to the network device 602. The network device 602 may estimate the parameter for the second electronic device 606 based on the relative pose measurements for the second electronic device 606 and the first value of the parameter (e.g., measured in respect of the first electronic device 604).

Embodiments of the disclosure thus provide high-resolution sensing for electronic devices. This may be particularly advantageous for electronic devices that have limited capability to perform sensing, such as low-power or limited-functionality devices. By enabling high-resolution sensing for electronic devices with limited capabilities, the need for additional sensing hardware (e.g., additional power capacity, increased bandwidth, and/or the like) can be avoided, reducing the cost of implementing network-wide sensing. Aspects of the present disclosure may be used to enable network-wide sensing with low capability (e.g., low resolution) devices.

In the method 800, the electronic device identified as the primary electronic device (e.g., the first electronic device 604) performs sensing in respect of the secondary electronic device (e.g., the second electronic device 606) to determine whether or not the parameter is a CSP. In other embodiments, this sensing may be performed by the secondary electronic device. An example implementation of this is described with respect of FIG. 9.

### Second Electronic Device-Based Sensing

FIG. 9 is a diagram illustrating interrelated methods in an overall method 900, where the interrelated methods are performed by the network device 602, the first electronic device 604, and the second electronic device 606.

The method 900 may begin with, in steps 902 and 904, the network device receiving first capability information from the first electronic device 604 and receiving second capability information from the second electronic device 606. Steps 902 and 904 may be performed in the same manner as steps 702 and 704 described above in respect of FIG. 7.

The network device 602 identifies the first electronic device 604 as the primary (e.g., prime) electronic device and the second electronic device 606 as the secondary (e.g., subprime) electronic device (not illustrated). The network device 602 may identify the first electronic device as the primary electronic device in the same manner as step 710 described above in respect of FIG. 7 or step 806 described above in respect of FIG. 8.

In step 906, the network device 602 indicates, to the first electronic device 604 that it is the primary electronic device. Step 908 may be performed in accordance with step 808, for example. The indication may be sent using semi-static signaling. The indication may be sent using medium access control-control element (MAC-CE) or radio resource control (RRC) signaling, for example. Alternatively, the indication may be sent using dynamic Li signaling, e.g., through DCI.

In step 908, the network device 602 may indicate, to the second electronic device 606 that the first electronic device 604 is the primary electronic device. The indication includes an identifier for the first electronic device 604. The identifier may be any suitable identifier such as, for example, an RNTI. The indication may be sent using semi-static signaling. The indication may be sent using medium access control-control element (MAC-CE) or radio resource control (RRC) signaling, for example. The indication may be sent using dynamic signaling such as Layer 1 signaling, for example using DCI.

In some examples, steps 906 and 908 may be performed together. For example, the network device 602 may broadcast the indication that the first electronic device 604 is the primary electronic device. The broadcast may be received by both the first and second electronic devices 604, 606.

Alternatively, step 906 may be performed and the first electronic device 604 may broadcast an indication that it is the primary electronic device. The first electronic device 604 may thus announce itself as the primary electronic device (e.g., responsive to receiving the indication in step 906). As such, step 908 may be omitted, since the second electronic device 606 may receive the indication broadcasted by the first electronic device 604. The indication may include the identifier for the first electronic device 604.

In step 910, the network device 602 may send a request, to the first electronic device 604, for transmission of one or more reference signals to the network device 602. The request may be sent using dynamic signaling, such as dynamic Li signaling.

In step 912, the first electronic device 604 may send one or more reference signals to the network device 602. Step 912 may be performed in accordance with step 706, for example. The one or more reference signals may be any suitable reference signals such as any of the uplink reference signals described above (e.g., one or more SRS, PRS, and/or the like).

Step 912 may be performed responsive to step 910. Alternatively, step 910 may be omitted. For example, the first electronic device 604 may send the one or more reference signals in step 912 responsive to receiving the indication that the first electronic device 604 that it is the primary electronic device in step 906.

In step 914, the network device 602 performs one or more measurements on the reference signals received in step 912. Based on the one or more measurements, the network device 602 determines a value of the parameter for the first electronic device. Step 914 may be performed in accordance with step 722, for example.

In step 916, the network device 602 obtains a first threshold value for a parameter and determines a second threshold value based on the first threshold value and the one or more measurements of the reference signals performed in step 914. The parameter and first threshold value may be as defined above in respect of the method 700 and 800. The obtaining of the first threshold value may be performed in accordance with step 712 or the obtaining the first threshold value by the network device 602 in the method 800.

The network device may determine first sensing information in respect of the first electronic device 604 and the network device 602 based on the one or more measurements of the reference signals performed in step 914 and use the first sensing information to determine a second threshold value. The determination of the second threshold value may be performed as described above in respect of step 824.

In step 918, the network device 602 sends the second threshold value to the second electronic device 606. The network device 602 may send the second threshold value using dynamic signaling such as Layer 1 signaling, for example DCI communicated in a PDSCH or a Physical Broadcast Channel (PBCH). Alternatively, it can be sent using semi-static signaling such as RRC or MAC-CE.

In step 920, the network device 602 sends a first sensing configuration to the second electronic device 606. The first sensing configuration may be sent using semi-static signaling. The first sensing configuration may be sent using MAC-CE or RRC signaling, for example. The first sensing configuration may be the same as the first sensing configuration described above in respect of FIG. 8, but in respect of the second electronic device 606, rather than the first electronic device 604. Thus, the first sensing configuration may configure the second electronic device 606 to perform sensing to detect the first electronic device 604.

In step 922, the network device 602 sends a second sensing configuration to the first electronic device 604. The second sensing configuration may be sent using semi-static signaling. The second sensing configuration may be sent using MAC-CE or RRC signaling, for example. The second sensing configuration may be the same as the second sensing configuration described above in respect of step 810, but in respect of the first electronic device 604, rather than the second electronic device 606. Thus, the second sensing configuration may configure the first electronic device 604 to embed an identifier for the first electronic device 604 in any sensing signal reflected by the first electronic device 604. The identifier may be any suitable identifier such as, for example, a Radio Network Temporary Identifier (RNTI). This may allow a recipient of the reflected signal to determine that the sensing signal was reflected by the first electronic device 604.

In step 924, the second electronic device 606 sends one or more sensing signals in accordance with the first sensing configuration. In step 926, the second electronic device 606 receives a reflection of one of the sensing signals that is reflected by the first electronic device 604. Steps 924 and 926 may be performed in accordance with steps 820 and 822 described above, except with the roles of the first and second electronic devices 604, 606 reversed.

In step 928, the second electronic device 606 compares second sensing information based on the reflected signal to the second threshold value to determine whether or not the parameter is a CSP for the first and second electronic devices 604, 606. Step 928 may be performed in accordance with step 826 or 728. For example, the second electronic device 606 may determine the separation d between the first and second electronic devices 604, 606 (an example of second sensing information) and compare the separation to a threshold value δ₂=r₁δ₁ to determine whether or not the AoD is a CSP for the first and second electronic devices 604, 606. By determining that the parameter is a CSP for the first and second electronic devices 604, 606 in step 928, spatial and/or temporal sensing correlations between electronic devices can be identified.

Responsive to determining that the parameter is a CSP for the first and second electronic devices 604, 606, in step 930 the second electronic device indicates to the network device 602 that the parameter is a CSP for the first and second electronic devices 604, 606. The second electronic device 606 may thus indicate, in step 930, that the network device 602 is to use one or more measurements of the parameter made in respect of the first electronic device 604 (e.g., based on one or more third signals transmitted between the first electronic device and the network device) for the second electronic device 606. The indication may be sent over a PUSCH, for example. Step 930 may be performed in accordance with step 828, with the second electronic device 606 performing the operations described in respect of the first electronic device 604. Thus, the second electronic device 606 may send the identifier of the first electronic device 604 to the network device 602.

The network device 602 may, responsive to receiving the indication, use the value of the parameter determined in step 914 for the second electronic device. The network device 602 may use the parameter as discussed above in respect of step 724, for example.

Steps 924-930 may be performed one or more times. Thus, for example, the second electronic device 606 may monitor whether or not the parameter is still a CSP over time. In some examples, steps 924-930 may be performed upon request by the network device 602. For example, the second electronic device may perform the sensing in steps 924-926 responsive to receiving an updated second threshold value from the network device 602. In other examples, steps 924-930 may be performed periodically.

### Finer Sensing

In some embodiments, rather than using measurements of the parameter made in respect of the first electronic device 604 (e.g. the value measured in step 914) for the second electronic device 606, an estimate of the parameter for the second electronic device 606 may be determined based on the value of the parameter measured in step 914 (in respect of the first electronic device 604) and sensing performed by the second electronic device 606 in respect of the first electronic device 604. This may be implemented in accordance with steps 832-840 described above. In some examples, this may be implemented in accordance with steps 832-840 above except with the sensing in steps 834 and 836 being performed by the second electronic device 606 and the parameter estimation in step 838 being performed by the network device 602. The second electronic device 606 may perform this additional sensing responsive to receiving a request from the network device (e.g., similar to the request in step 832). Alternatively, the second electronic device 606 may perform the additional sensing periodically. In some examples, the second electronic device 606 may perform this additional sensing until an indication is received, from the network device 602, to stop (or turn off) the additional sensing.

### Alternative Local Sensing Techniques

As described above, sensing may be performed between the first and second electronic devices 604, 606 to determine whether or not a parameter is a CSP for the first and second electronic devices 604, 606 and/or to obtain a more accurate estimate of the parameter in respect of the second electronic device 606. This sensing may be referred to as local sensing (e.g., in contrast to sensing between the electronic devices 604, 606 and the network device 602). Local sensing may thus be used to capture local correlations between parameters for the first and second electronic devices 604, 606. In the aforementioned embodiments, local sensing is mainly described as being performed using backscattering. That is, the above descriptions of local sensing involve using a reflected signal to determine pose information. In general, any suitable sensing techniques may be used for local sensing. Thus, any suitable sensing techniques may be used to determine pose information indicative of a relative pose between the first electronic device 604 and the second electronic device 606 (e.g., the first electronic device 604 relative to the second electronic device 606 or vice-versa). Thus, for example, one or more of the following techniques may be used: backscattering (e.g., RADAR and/or LIDAR), imaging (e.g., using a camera), GNSS and reference-signal based techniques. For example, step 726 in the method 700 may implement one or more of these techniques. Steps 820-822, 834-836 and/or 924-926 may be replaced or supplemented by operations for implementing an alternative technique(s) (e.g., imaging and/or active sensing techniques, such as reference signal measurements).

### Alternatives to Reference Signal-Based Sensing Techniques

In the foregoing description of the methods 700, 800 and 900, one or more reference signals may be transmitted between the network device 602 and one or both of the first and second electronic devices 604, 606 to determine a value of the parameter and/or to determine relative pose information for the electronic devices 604, 606. The use of reference signals to determine a value of the parameter and/or relative pose information may be considered as an example sensing technique. In general, any technique may be used to determine the value of the parameter and/or the relative pose information. In some examples, other sensing techniques may be employed, such as backscatter techniques (e.g., RADAR and/or LIDAR) or imaging. For example, rather than sending a request for one or more reference signals to the first electronic device in step 910, the network device 602 may transmit a sensing signal towards the first electronic device 604 and, in step 912, receive a reflection of the sensing signal, reflected by the first electronic device 604. In another example, the network device 602 may, rather than receiving one or more respective reference signals from the first and second electronic devices 604, 606 in steps 706, 708 and 720, receive one or more respective other sensing signals. For example, the network device 720 may transmit one or more respective first sensing signals and receive, in steps 706, 708 and 720, respective reflected signals comprising a reflection of the one or more respective first sensing signals as reflected by the relevant electronic device. Alternative sensing techniques may thus be in place of the reference signal-based techniques described herein.

### Multiple CSPs

In the above descriptions of the method 700, 800 and 900, threshold values are determined in respect of one parameter and used to determine whether that parameter is a CSP for the first and second electronic devices 604, 606. In general, any of the methods 700, 800 and 900 may be performed in respect of one or more parameters. The one or more parameters may include any combination of the parameters discussed above in respect of step 712 and/or any of the parameters discussed above in respect of FIG. 6, for example. In some embodiments, the methods may be performed in respect of two or more parameters.

In one example implementation of the method 700, the network device 602 may obtain respective threshold values for one or more parameters in step 712. The network device 602 may, in step 714 determine that some or all of the one or more parameters are CSPs. Steps 716-730 may thus be performed in respect of the parameters that are determined to be CSPs.

### Primary Apparatus and Secondary Apparatus

In the above descriptions of the methods 700, 800 and 900, the methods are performed in respect of a network device and two electronic devices, with one electronic device being identified as a primary electronic device and another electronic device being identified as the secondary electronic device. In general, any of the methods described herein may be performed in respect of a network device and two or more apparatus, in which at least one (e.g., one) apparatus is identified as a primary apparatus and at least one apparatus is identified as a secondary apparatus. As such, the methods 700, 800 and 900 may be implemented for two or more apparatus with, for example, a first apparatus performing the operations described above in respect of the first electronic device 604 and two or more (e.g., a plurality or at least two) second apparatus performing the operations described above in respect of the second electronic device 606. The first and second apparatus may comprise any suitable apparatus, such as, for example, one or more of the electronic devices 110 described above in respect of FIGS. 1-4 and/or one or more network devices, such as any of the TRPs 170 described above in respect of FIGS. 1-4. The first and second apparatus may, in some examples, be sensing nodes (e.g., as defined above).

In particular embodiments, an estimate of a parameter obtained using finer sensing performed in respect of some of (e.g. one of) the two or more second apparatus may be used for other apparatus in the two or more second apparatus. For example, steps 838 and 840 described above may be implemented in respect of one apparatus identified as a secondary apparatus to obtain a refined parameter estimate, and the refined parameter estimate may be used for one or more other apparatus identified as a secondary apparatus.

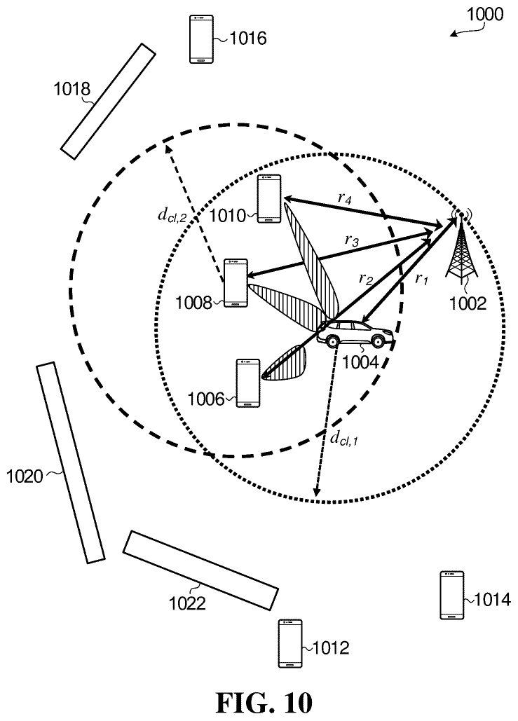

FIG. 10 shows another example of a system 1000 according to embodiments of the disclosure. The system 1000 includes a network device 1002, a first electronic device 1004, and a plurality of second electronic devices 1006, 1008, 1010, 1012, 1014, and 1016 (collectively 1006-1016). The system 1000 is in an environment including obstacles 1018, FF20 and FF22, which may impede or reflect signals (e.g., radio signals).

The network device 1002 may be a TRP or a base station, such as any of the TRPs 170 described above in respect of FIGS. 1-4. The first electronic device 1004 and the second electronic devices 1006-1016 may respectively be any suitable electronic device, such as any of the electronic devices 110 described above in respect of FIGS. 1-4. Although FIG. 10 illustrates the first electronic device 1004 as being a vehicle (e.g., a car) and the second electronic devices 1006-1016 as being handsets (e.g., smartphones or tablets), the present disclosure is not limited as such.

The first electronic device 1004 is identified as a primary electronic device based on its capability information. The second electronic devices 1006-1016 are identified as secondary electronic devices based on their respective capability information. The identification of the primary and secondary electronic devices may be performed as described above in any of the methods 700, 800 and 900.

Any of the methods 700, 800 and 900 may be implemented in the system 1000 to determine whether one or more parameters are CSP for some or all of the second electronic devices 1006-1016.

The range may be determined to be a CSP for the first electronic device 1004 and a respective second electronic device 1006-1016 provided the separation between the first electronic device 1004 and a respective second electronic device 1006-1016 is less than a threshold value δ<d_{cl,1}. This distance d_{cl,1} may be referred to as the scanning or local sensing span of the first electronic device 1004. As illustrated in FIG. 10, only a first subset of the second electronic devices 1006, 1008 and 1010 are within this radius of the first electronic device 1004. Thus, the range of the first electronic device, r₁, may be used to estimate the ranges of the first subset of the second electronic devices 1006, 1008, 1010, r₂, r₃ and r₄. The network device 1002 may, for example, assume r₂=r₁, r₃=r₁ and r₄=r₁. Alternatively, any of the finer sensing techniques described above may be implemented to use local sensing in combination with the measurement of r₁ to estimate r₂, r₃ and r₄.

FIG. 10 also shows a second dashed circle centred on one of the second electronic devices 1008. The circle shows the scanning or local span of the second electronic device 1008. As the radius of this circle is d_{cl,2}, which is different to d_{cl,1}, the first electronic device 1004 and the second electronic device 1008 are configured with different sensing spans for local sensing. The respective sensing spans of the first and second electronic devices 1004, 1006-1016 may be determined based on the threshold δ at the primary electronic device (e.g., at the first electronic device 1004) or at one of the secondary electronic devices (e.g., at any of the second electronic devices 1006-1016). In some examples, the respective sensing spans may be determined at the electronic devices configured to perform sensing in respect of another electronic device.

In an example, steps 702-714 may be performed in respect of all of the second electronic devices 1006-1016 and, in step 714, the network device 1002 may determine the range is a CSP for the first subset of the second electronic devices 1006, 1008, 1010, but not for the second subset of the second electronic devices 1012, 1014 and 1016. As such, steps 716-730 of the method 700 may be performed in respect of the range for the first electronic device 1004 and the first subset of the second electronic devices 1006, 1008, 1010. In contrast, steps 716-730 of the method 700 might not be performed in respect of a second subset of the second electronic devices 1012, 1014 and 1016.

In another example, steps 802-826 of the method 800 may be performed in respect of all of the second electronic devices 1006-1016 and, in step 828, the first electronic device 1004 may indicate to the network device 1002 that the range is a CSP for the first subset of the second electronic devices 1006, 1008, 1010 but not for the second subset of the second electronic devices 1012, 1014 and 1016. Steps 832-840 of the method 800 may thus be performed in respect of the first subset of the second electronic devices 1006, 1008, 1010 but not the second subset of the second electronic devices 1012, 1014 and 1016.

In another example, steps 902-928 may be performed in respect of all of the second electronic devices 1006-1016. In step 928, each of the first subset of the second electronic devices 1006, 1008, 1010 may determine that the range is a CSP and notify the network device 1002 accordingly in step 930. However, the second subset of the second electronic devices 1012, 1014 and 1016 may determine, in step 928, that the range is not a CSP and may indicate to the network device 1002 in step 930 that the range is not a CSP. Responsive to the indications, the network node 1002 may use measurements of the range r₁ for the first subset of the second electronic devices 1006, 1008, 1010 but not for the second subset of the second electronic devices 1012, 1014 and 1016.

Embodiments of the disclosure thus provide methods in which one or more parameters may be determined to be CSPs between electronic devices, which allows spatial and/or temporal sensing correlations between electronic devices to be identified. Cooperative sensing procedures are provided for exploiting these correlations, which enables a low signaling overhead sensing for some electronic devices (e.g., those with limited capabilities such as low bandwidth and power). By obtaining an indication at a network device (e.g., at the network) that parameters are CSPs, the power and the signaling overhead required for sensing all parameters of different electronic devices can be reduced.

### Additional Methods

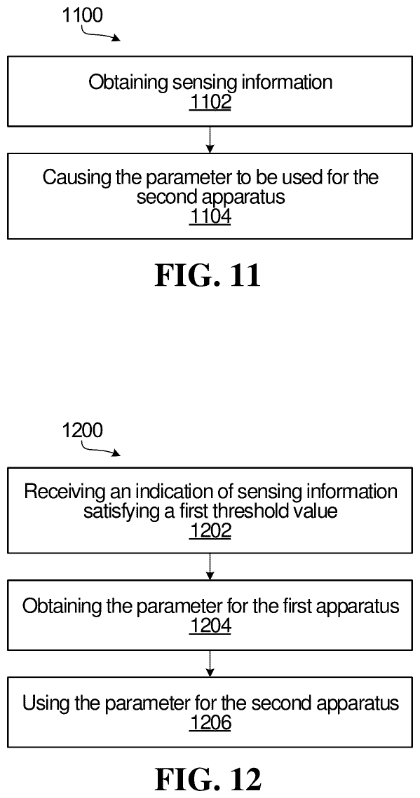

FIG. 11 shows a flowchart of a method 1100 according to embodiments of the disclosure.

The method 1100 may be performed by a network device. The network device may a base station or TRP, such as one of the TRPs 170 described above in respect of FIGS. 1-4. The network device may be in a radio access network (e.g., one of the radio access networks 130 described above in respect of FIGS. 1-4). In some examples, the method 1100 may be performed by the network device 602.

The method 1100 may be performed by an electronic device, such as one of the electronic devices 110 described above in respect of FIGS. 1-4. In some examples, the method 1100 may be performed by the first electronic device 604 or the second electronic device 606.

The method 1100 may begin with obtaining a threshold value. The threshold value may be any of the threshold values described above in respect of FIGS. 6-9 (e.g., any of the first or second threshold values). The threshold value may be obtained in accordance with any of steps 712, 814 or 918, for example.

Obtaining the threshold value may involve retrieving the threshold value from memory. Alternatively, obtaining the threshold value may involve receiving the threshold value (e.g., from a network device or electronic device). In yet a further alternative, obtaining the threshold value may comprise determining the threshold value. For example, the threshold value may be a second threshold value and the method may comprise determining the second threshold value based on a first threshold value and one or more measurements performed on one or more signals (e.g., one or more reference signals) transmitted between a network device (e.g., the network device 602) and a first apparatus (e.g., the first electronic device 604). In another example, the method may comprise determining the second threshold value based on a first threshold value and sensing information in respect of the network device and the first apparatus (e.g., as described above in step 824). The first threshold value may be the first threshold value referred to in step 712 or step 814, for example. The second threshold value may be the second threshold value referred to in step 728 or step 824, for example.

The threshold value may be associated with a parameter and/or sensing information. The sensing information is described in below in respect of step 1102.

The parameter may be any of the parameters referred to above as potentially being determined to be CSP. The parameter may thus comprise one or more of: range (e.g., time of flight, such as round-trip travel time or delay), angle between electronic devices, Angle of Arrival and Angle of Departure, channel subspace, Doppler shift (e.g., a frequency shift due to relative movement of the respective electronic device), orientation vector and velocity. In particular examples, the parameter may be a sensing parameter such as pose parameter.

In step 1102, the method 1100 involves obtaining sensing information related to the parameter. The sensing information is associated with a first apparatus and a second apparatus. The first apparatus may be the first electronic device 602. The second apparatus may be the second electronic device 604. The sensing information may thus characterise the first apparatus and the second apparatus. The sensing information may be referred to as joint sensing information for the first and second apparatus. The sensing information may be a single quantity or value.

It will be appreciated that the relationship between the sensing information and the parameter will vary depending on the parameter and the nature of the sensing information. In some examples, the sensing information may comprise a ratio or difference between a measurement of the parameter for the first apparatus and a measurement of the parameter for the second apparatus (e.g., as described above in the method 700). The measurements may be based on one or more reference signals or one or more sensing signals.

The sensing information may be based on pose information indicative of a relative pose between the first apparatus and second apparatus. The pose information may be indicative of a relative pose of the first apparatus with respect to the second apparatus or, equivalently, a relative pose of the second apparatus with respect to the first apparatus.

The sensing information may be any of: the sensing information described above in respect of FIG. 6, the sensing information or the second sensing information for the first and second electronic devices 604, 606 in the method 700, the combined sensing information described above in the method 800, and the second sensing information described above in the method 900.

In some embodiments, step 1102 may comprise performing sensing to determine a relative pose between the first apparatus and the second apparatus. Step 1102 may comprise performing steps 820-824 (or steps 816-824) of the method 800. Step 1102 may comprise performing steps 924-926 of the method 900, for example.

The method further involves, in step 1104, causing a network device to use, for the second apparatus, one or more measurements of the parameter determined based on one or more first signals transmitted between the first apparatus and the network device. The network device may be the network device 602.

The one or more first signals may be transmitted by the first apparatus to the network device. For example, the one or more first signals may be the one or more reference signals received at the network device 602 from the first electronic device 604 in step 706 or step 720 of the method 700. In another example, the one or more first signals may be the one or more reference signals received at the network device 602 from the first electronic device 604 in step 912 of the method 900. Alternatively, the one or more first signals may be transmitted by the network device to the first apparatus. For example, the one or more first signals may be the one or more reference signals sent by the network device 602 to the first electronic device 604 in step 816 of the method 800.

The one or more first signals may comprise one or more reference signals, such as one or more uplink reference signals or one or more downlink reference signals.

Step 1104 is performed responsive to the sensing information satisfying the threshold value. The sensing information may thus be compared to the threshold value to determine whether the threshold value is satisfied.

As the one or more measurements of the parameter are determined based on one or more first signals transmitted between the first apparatus and the network device, the one or more measurements of the parameter may be referred to as being for or specific to the first apparatus.

Causing the network device to use the one or more measurements of the parameter for the second apparatus may involve indicating to the network device to use the one or more measurements for the second apparatus. Thus, for example, step 1104 may comprise sending an indicator to the network device indicating that one or more measurements of the parameter performed in respect of (e.g., by or for) the first apparatus may be used for the second apparatus. This may alternatively be referred to as indicating to the network device that the parameter is a co-sensed parameter (CSP) for the first and second apparatus.

In embodiments in which the method 1100 is performed by the network device, causing the network device to use the one or more measurements of the parameter for the second apparatus comprises using the one or more measurements of the parameter for the second apparatus.

In a further aspect, an apparatus (e.g., an entity) configured to perform the method 1100 is also provided. The apparatus may be a network device (e.g., one of the TRPs 170) or an electronic device (e.g., one or the electronic devices 110), for example. The apparatus may include a processor and a memory (e.g., a non-transitory processor-readable medium). The memory stores instructions (e.g., processor-readable instructions) which, when executed by a processor of an apparatus, cause the apparatus to perform the method 1100. In another aspect, the memory may be provided (e.g., separate to the apparatus).

FIG. 12 shows a flowchart of a method 1200 according to embodiments of the disclosure.

The method 1200 may be performed by a network device. The network device may a base station or TRP, such as one of the TRPs 170 described above in respect of FIGS. 1-4. The network device may be in a radio access network (e.g., one of the radio access networks 130 described above in respect of FIGS. 1-4). In some examples, the method 1200 may be performed by the network device 602.

The method may begin, in step 1202, with receiving an indication of sensing information related to a parameter satisfying a first threshold value. The indication may be received from a first apparatus or a second apparatus. The sensing information is associated with both the first apparatus and the second apparatus. The first threshold value is associated with (e.g., may be specific to) a parameter. Step 1202 may be performed in accordance with step 828 or 930 described above, for example.

In step 1204, one or more measurements of the parameter are obtained. The one or more measurements are based on one or more first signals transmitted between the first apparatus and the network device. Obtaining the one or more measurements may comprise receiving the one or more measurements from the first apparatus. Alternatively, obtaining the one or more measurements may comprise performing the one or more measurements on the one or more first signals (e.g., as described above in steps 720-722 or steps 912-914). The one or more first signals may comprise one or more reference signals.

In step 1206, the one or more measurements of the parameter are used for the second apparatus. Step 1206 may be performed in accordance with step 724 described above. Using the one or more measurements of the parameter for the second apparatus may comprise setting a value of the parameter for the second apparatus equal to the one or more measurements. Alternatively, using the one or more measurements may involve obtaining an estimate of the value of the parameter for the second apparatus based on the one or more measurements (e.g., as described above in step 838).

In a further aspect, an apparatus (e.g., an entity) configured to perform the method 1200 is also provided. The apparatus may be a network device, such as one of the TRPs 170 described above in respect of FIGS. 1-4. The apparatus may include a processor and a memory (e.g., a non-transitory processor-readable medium). The memory stores instructions (e.g., processor-readable instructions) which, when executed by a processor of an apparatus, cause the apparatus to perform the method 1200. In another aspect, the memory may be provided (e.g., separate to the apparatus).

### CLOSING PARAGRAPHS

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

What is claimed is:

1. A method comprising:
obtaining sensing information related to a parameter, wherein the sensing information is associated with both a first apparatus and a second apparatus; and
in response to the sensing information satisfying a threshold value, causing a network device to use, for the second apparatus, one or more measurements of the parameter determined based on one or more first signals transmitted between the first apparatus and the network device.

2. The method of claim 1, wherein causing the network device to use, for the second apparatus, the one or more measurements of the parameter comprises:
indicating, to the network device, to use the one or more measurements of the parameter for the second apparatus.

3. The method of claim 2, wherein the method is performed by one of the first apparatus and the second apparatus, and wherein obtaining the sensing information comprises performing sensing to determine a first relative pose between the first apparatus and the second apparatus.

4. The method of claim 3, wherein performing the sensing comprises:
transmitting one or more second signals towards another of the first apparatus and the second apparatus;
receiving a reflected signal comprising a reflection of at least one of the one or more second signals reflected by the other of the first apparatus and the second apparatus; and
performing one or more measurements on the reflected signal to determine the first relative pose.

5. The method of claim 3, wherein the method is performed by the first apparatus and the method further comprises:
performing one or more measurements on one or more reference signals received from the network device to determine the sensing information.

6. The method of claim 3, wherein the threshold value is based on one or more measurements performed on one or more reference signals transmitted between the network device and the first apparatus.

7. A method performed by a network device, the method comprising:
receiving an indication, from a first apparatus or a second apparatus, of sensing information related to a parameter satisfying a first threshold value, and wherein the sensing information is associated with both the first apparatus and the second apparatus;
obtaining one or more measurements of the parameter based on one or more first signals transmitted between the first apparatus and the network device; and
using the one or more measurements of the parameter for the second apparatus.

8. The method of claim 7, further comprising:
obtaining capability information for the first apparatus and the second apparatus, the capability information indicating a capability of the first apparatus and the second apparatus to perform sensing; and
based on the capability information, indicating to the first apparatus that one or more second signals are to be transmitted between the first apparatus and the network device for one or more further measurements of the parameter.

9. The method of claim 8, further comprising:
based on the capability information, configuring one of the first apparatus and the second apparatus to perform sensing with respect to the other of the first apparatus and the second apparatus to determine the sensing information.

10. The method of claim 8, wherein obtaining the capability information for the first apparatus and the second apparatus comprises obtaining, for at least one of the first apparatus or the second apparatus, one or more of:
an indication of a functionality of the respective apparatus;
an availability of the respective apparatus; or
a mode of the respective apparatus.

11. An apparatus in a group of apparatuses comprising a first apparatus and a second apparatus, the apparatus comprising:
at least one processor; and
at least one memory storing instructions which, when executed by the at least one processor, cause the apparatus to:
obtain sensing information related to a parameter, wherein the sensing information is associated with both the first apparatus and the second apparatus; and
in response to the sensing information satisfying a threshold value, cause a network device to use, for the second apparatus, one or more measurements of the parameter determined based on one or more first signals transmitted between the first apparatus and the network device.

12. The apparatus of claim 11, wherein, when the instructions are executed by the at least one processor, the apparatus is caused to:
cause the network device to use, for the second apparatus, the one or more measurements of the parameter by indicating, to the network device, to use the one or more measurements of the parameter for the second apparatus.

13. The apparatus of claim 12, wherein the apparatus comprises one of the first apparatus and the second apparatus and wherein, when the instructions are executed by the at least one processor, the apparatus is caused to:
obtain the sensing information by performing sensing to determine a first relative pose between the first apparatus and the second apparatus.

14. The apparatus of claim 13, wherein, when the instructions are executed by the at least one processor, the apparatus, to perform the sensing, is caused to:
transmit one or more second signals towards another of the first apparatus and the second apparatus;
receive a reflected signal comprising a reflection of at least one of the one or more second signals reflected by the other of the first apparatus and the second apparatus; and
perform one or more measurements on the reflected signal to determine the first relative pose.

15. The first apparatus of claim 13, wherein the apparatus comprises the first apparatus and wherein, when the instructions are executed by the at least one processor, the first apparatus is further caused to:
perform one or more measurements on one or more reference signals received from the network device to determine the sensing information.

16. The first apparatus of claim 13, wherein the threshold value is based on one or more measurements performed on one or more reference signals transmitted between the network device and the first apparatus.

17. A network device, comprising:
at least one processor; and
at least one memory storing instructions which, when executed by the at least one processor, cause the network device to:
receive an indication, from a first apparatus or a second apparatus, of sensing information related to a parameter satisfying a first threshold value, wherein the sensing information is associated with both the first apparatus and the second apparatus;
obtain one or more measurements of the parameter based on one or more first signals transmitted between the first apparatus and the network device; and
use the one or more measurements of the parameter for the second apparatus.

18. The network device of claim 17, wherein, when the instructions are executed by the at least one processor, the network device is further caused to:
obtain capability information for the first apparatus and the second apparatus, the capability information indicating a capability of the first apparatus and the second apparatus to perform sensing; and
based on the capability information, indicate to the first apparatus that one or more second signals are to be transmitted between the first apparatus and the network device for one or more further measurements of the parameter.

19. The network device of claim 18, wherein, when the instructions are executed by the at least one processor, the network device is further caused to:
based on the capability information, configure one of the first apparatus and the second apparatus to perform sensing with respect to the other of the first apparatus and the second apparatus to determine the sensing information.

20. The network device of claim 18, wherein, when the instructions are executed by the at least one processor, the network device is caused to:
obtain the capability information for the first apparatus and the second apparatus by obtaining, for at least one of the first apparatus or second apparatus, one or more of:
an indication of a functionality of the respective apparatus;
an availability of the respective apparatus; or
a mode of the respective apparatus.
